(19) United States
(12) Patent Application Publication
(10) Pub. No.: US 2009/0287592 A1
(43) Pub. Date: Nov. 19, 2009

(54) SYSTEM AND METHOD FOR CONFERRING A BENEFIT TO A THRID PARTY FROM THE SALE OF LEADS

(75) Inventors: Bruce F. Brooks, Austin, TX (US); Siew-Yee Lee, Austin, TX (US)

Correspondence Address: THE JANSSON FIRM, 3616 Far West Blvd, Ste 117-314, AUSTIN, TX, 78731, US

(73) Assignee: WORTHYBIDS LLC, Austin, TX (US)

(21) Appl. No.: 12/121,528

(22) Filed: May 15, 2008

(51) Int. Cl. G06Q 40/00

(52) U.S. Cl. 705/35

(57) ABSTRACT

A computer system and method for operating a computer system to confer a benefit to a third party recipient from the sale of leads. Receiving a lead entry from the lead contributor, the lead entry having a lead description describing a desired good or service. Transmitting an alert of the lead to potential providers inviting the potential providers to buy a share in the lead. Upon receiving a lead purchase request from the requesting potential provider including a payment for the lead, processing the lead purchase request including crediting an account of a third party recipient with a portion of the payment.

### BACKGROUND OF THE INVENTION

The present invention relates generally to computer based business methods and particularly to a method for operating a computer system to confer a benefit to a third party from the sale of leads.

The current era is often referred to as the information age; an era in which value creation is not primarily from the production and sale of goods, but by the creation and manipulation of information. However, even with powerful tools for creating, storing, disseminating, and sharing information, in many fields capitalizing on the intrinsic value of information has been elusive.

One category of information that has a great deal of value, but whose value has hitherto not been fully exploited, is sales leads. A sales lead is an item of information relating to the identity of a prospective purchaser of a good or service. Associated with the lead are related items of information such as which good or service is to be purchased, when the purchase is to be made, the potential method of purchase, etc.

The high value of leads can be inferred from several pieces of anecdotal evidence that are commonly known. For example, most homeowners receive regular mailing from Realtors essentially for the purpose of soliciting listings and potential new clients. There are networks, known as lead circles, where the network members meet regularly to share leads such as, for example, the knowledge that a business is moving and therefore may be in need of new equipment and services.

Furthermore, there are commercial lead sellers who attempt to sell leads. One category of lead sellers provides a mechanism for potential customers of goods and services to enter a quote request. These quote requests are forwarded to potential providers who may purchase the leads for a fee. Providers are vendors of a good or of a service. One such lead service is Quotecatcher.com. Quotecatcher provides a mechanism in which a potential customer uses an interface to request quotes in any of a number of business service areas. These requests for quotes are qualified and then sent to subscribers of the service. Other than providing a mechanism in which buyers may receive multiple quotes for a desired product or service, the buyers, who are in fact the originators of the leads, have very little personal advantage in using a lead seller to obtain quotes.

The value of leads depends greatly on the quality of the lead. One way to differentiate leads is to distinguish between unqualified leads and qualified leads. An unqualified lead may be something that is little more than a hunch, e.g. that a relocating company has a need for new furniture or technical equipment for the new office. However, the case may be that that hunch is incorrect, e.g. the company is moving all its old furniture and has already entered into a contract for any new furniture it may need at the new location. A qualified lead, on the other hand, is one in which there is defined need of a good or service, e.g., the company itself is requesting that bids for office furniture be provided by office furniture vendors.

Prior art lead brokerages have very poor access to qualified leads because there is no incentive to the entity that wishes to purchase a good or service to provide that information to the lead brokerage.

The desire to assist worthy causes is a very common trait. Most individuals strive to perform charitable acts. The mode in which we execute charity varies; for example, some donate a portion of their income to designated causes, others volunteer time and services, and others donate unwanted items to charities either for the direct use by the charity or so that the charity may in turn sell the item for fundraising.

There are examples where individuals seek to benefit a charity by purchasing goods from the charity or goods that benefit a charity. For example, most everyone is familiar with Girl Scout Cookies, which are sold by Girl Scouts of the USA to raise funds. An example of a second category is the Newman's Own food company. While the company is a for-profit corporation, the after-tax profits are donated to charity. In each of these categories, some consumers select the product based on company policy of donating profits to charity. There are at least two limitations to this model of meeting a consumer's desire to generate funds for charities as a byproduct of doing needed business. First, only demand for the particular goods offered can be used for fundraising; if a person has no interest in purchasing Girl Scout Cookies, purchasing the cookies would be a burden and, consequently, the transaction would be an inefficient mechanism for generating funds for the Girl Scouts. Second, the purchaser has no control over the destination of the funds. For example, there may be little public information available about the charities that are supported by a particular product brand. Consequently, individual or corporate consumers have very little opportunity to use their demand for goods and services to generate revenue for charities of their liking.

From the foregoing it is apparent that there is still a need for an improved method for capitalizing the value of leads, in particular, qualified leads, to realize a financial benefit for designated third-party recipients, for example, non-profit organizations.

### BRIEF DESCRIPTION OF THE DRAWINGS

FIG. 1 is a high-level schematic illustration of a lead broker system that conveys a benefit from sale of shares in leads to designated third parties.

FIG. 2 is a high-level timing sequence diagram illustrating message flow between the lead contributor, the lead broker, potential providers, and the intended third-party recipient in the lead broker system of FIG. 1.

FIG. 3 is a schematic illustration of an operating environment in which the lead broker system of FIGS. 1 and 2 may operate.

FIG. 4 is a schematic illustration of a lead broker computer web server computer used by the lead broker system illustrated in FIGS. 1 through 3.

FIG. 5 is a block diagram illustrating major functional modules of the lead broker system directing the operation of the lead broker webserver illustrated in FIG. 4.

FIG. 6 is a block diagram illustrating the sub-modules of the Profile Entry and Management module of the lead brokerage system introduced in FIGS. 4 and 5.

FIG. 7 is a block diagram illustrating the sub-modules of the lead input and processing module of the lead brokerage system introduced in FIGS. 4 and 5.

FIG. 8 is a high-level workflow diagram of the lead entry and processing module.

FIG. 9 is a timing sequence diagram illustrating the operations performed by lead broker system in response to a lead contributor contributing a lead using the lead input sub-module of the lead entry and processing module of FIG. 8.

FIG. 10 is an illustrative lead input template provided to a lead contributor and displayed in a browser window on the computer of the lead contributor.

FIG. 11 is a timing sequence diagram illustrating message flow and processing performed by the existing vendor checking sub-module of the lead entry and processing module.

FIG. 12 is a flowchart illustrating the operations of the lead abstraction module of the lead entry and processing module.

FIG. 13 is a flowchart illustrating the operations and dataflow of the lead matching and alerting module of the lead entry and processing module.

FIG. 14 is a high-level block diagram illustrating the sub-modules of the lead share selling module of the lead-entry and processing module.

FIG. 15 is a timing-sequence diagram illustrating the processing and message flow of the lead share selling module of the lead-entry and processing module.

FIG. 16 is a timing-sequence diagram illustrating the processing and message flow associated with a disqualification message received from a lead contributor.

FIG. 17 is a timing-sequence diagram illustrating the operations and message flow related to the pricing module of the lead share selling module.

FIG. 18 is a flowchart illustrating the operation of a module for globally adjusting the pricing of first shares sold within particular sub-categories.

FIG. 19 is a flowchart illustrating the operation of the lead pricing module when operating according to a continuous sealed auction method for share pricing.

FIG. 20 is a flowchart illustrating the operation of a module for globally adjusting the pricing of first shares sold within particular sub-categories in the continuous sealed auction.

FIG. 21 (separated into FIGS. 21(a) and 12(b)) is an example database schema used by the lead brokerage system.

FIG. 22 is an example custom portal showing a dashboard for a provider-user of the lead broker system.

FIG. 23 (separated into FIGS. 23(a) and 23(b)) is a timing-sequence diagram illustrating the processing of the post-sale processing module and related message flow.

FIG. 24 is an example screen shot of a portal page for a lead contributor including a dashboard for the lead contributor.

FIG. 25 is an example screen shot of a portal page for a provider-user of the lead broker system wherein a continuous sealed auction approach is employed to sell shares in leads.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. Furthermore, where a subset of a set is referred to, the entire set may be considered such a subset, unless the contrary is explicitly stated. Also, a portion of a quantity or of a set includes the entire quantity or the entire set, respectively. In the drawings, like numerals refer to the same or similar functionality throughout the several views.

A lead broker system and method described herein provides a mechanism by which individuals and businesses in need of goods or services can benefit designated third parties, such as charities of their choice, by entering sales leads in the lead broker system for sale to potential providers of the desired goods or services. When potential providers identify sales leads for which they are interested in providing a bid, the provider purchases a share in the lead from the lead broker system. The information associated with a lead may be purchased by multiple potential providers. Each such purchase is referred to herein as one share in the lead. A lead contributor 103 may specify that only one share is to be sold. Similarly, in one embodiment of the invention, multiple shares are not offered for any given lead. A portion of the payment for the purchase of the share in the lead is provided to the designated third-party recipient. Herein the word recipient is used to designate a third party who receives a benefit from the sale of shares in a lead. A lead contributor may be a third-party recipient from the sale of shares in a lead. However, in one embodiment, providers of goods and services are not permitted to be recipients from leads in categories of goods and services for which they act as providers.

An example use of a lead broker system as described herein to generate funds for a charity may be a corporation in need of two new copiers. The corporation contributes the leads to the lead broker system and designates a charity, as a third-party recipient, to benefit from the sale of the lead. The lead broker system packages the lead and forwards the lead to all of the copier companies which are signed up with the lead broker system for receiving leads for purchase; in a preferred embodiment, leads are categorized and forwarded to appropriate potential providers. The packaging of the leads generally involves ensuring the anonymity of the lead. In the copier example, the lead is forwarded to all of the copier providers in the system. Four of the providers purchase a share in the lead and each share may be priced at $150, thus raising a total of $600. A portion of that, for example, 80% is forwarded to the third-party recipient. Thus, the information that the corporation is in need of two copiers has been converted to a $480 benefit for the third-party recipient which was designated by the contributor of the lead.

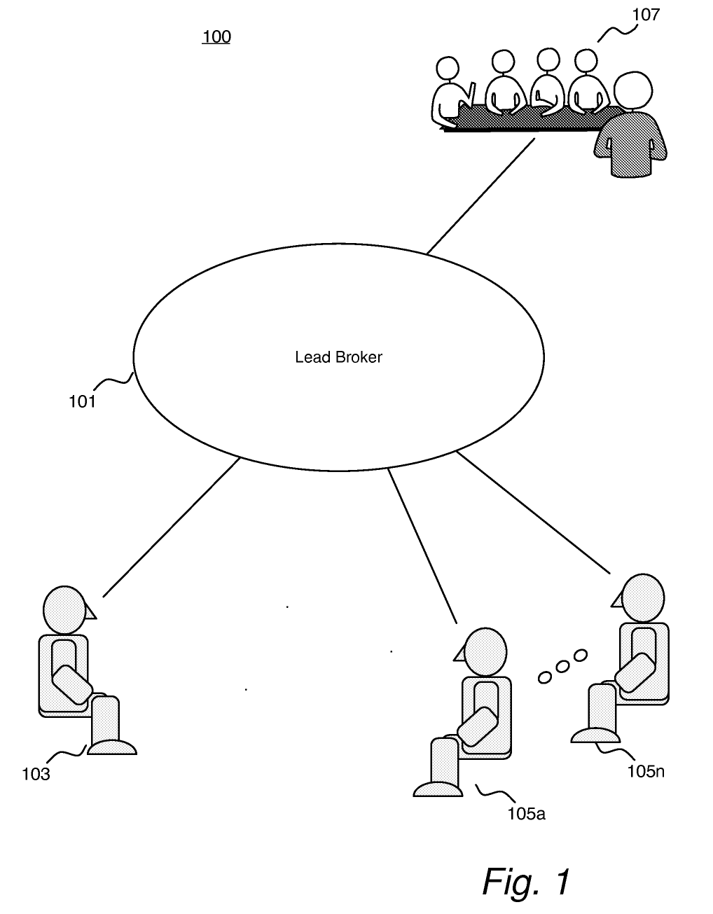

FIG. 1 is a high-level schematic illustration of a lead broker system 100 that conveys a benefit from sale of shares in leads to designated third parties. A lead broker 101 manages the receipt of leads, the sale of leads, and the release of generated funds to third-party recipients. When a lead contributor 103 is interested in using a need for a good or service to benefit a cause, the lead contributor 103 communicates that need for a good or service to the lead broker 101. The lead contributor 103 also designates an intended third-party recipient 107. The lead broker 101 prices the leads and provides a description of the lead to potential providers 105a-105n of the goods or services. If a potential provider 105 wishes to purchase a share in a lead, the provider 105 purchases the share in the lead from the lead broker 101. A portion of the funds tendered for the purchase of the lead is credited to the intended third-party recipient 107. The lead contributor 103 is informed of all the share purchases made for a particular lead and may select any one of the potential providers 105 for obtaining the goods or services. The lead contributor 103 and the selected potential provider 105 enter into a transaction by which the selected potential provider 105 provides the desired goods or services to the lead contributor 103. In a preferred embodiment, the resulting transaction between the lead contributor 103 and the selected provider 105 takes place externally to the lead broker 101.

Thus, there are at least four types of entities associated with a system implementing a lead broker 101 as illustrated in FIG. 1: the lead broker, lead contributors, providers of goods and services, and third-party recipients. As used herein, the term potential provider is a provider who has the potential to fulfill a request for goods or services presented through a lead.

In one scenario, discussed in greater detail below in conjunction with an example, one entity may take multiple roles, even with respect to one lead. For example, a lead contributor may designate itself as the third-party recipient, from the sale of shares in a lead. This scenario is attractive for use by non-profit organizations contributing leads.

The individuals who actually interact with the lead broker 101 are referred to herein as users. One entity may be served by multiple users. Users may take on different roles in interacting with the lead broker 101, e.g., a particular user may be a lead contributor, may be a provider, and may be a third-party recipient. In the scenario in which a lead contributor is also a third-party recipient, one user associated with the entity may be the lead contributor and another may be the recipient. However, even that distinction is not necessary; one entity that is both a lead contributor and a third-party recipient for a given lead, may have one user perform both roles.

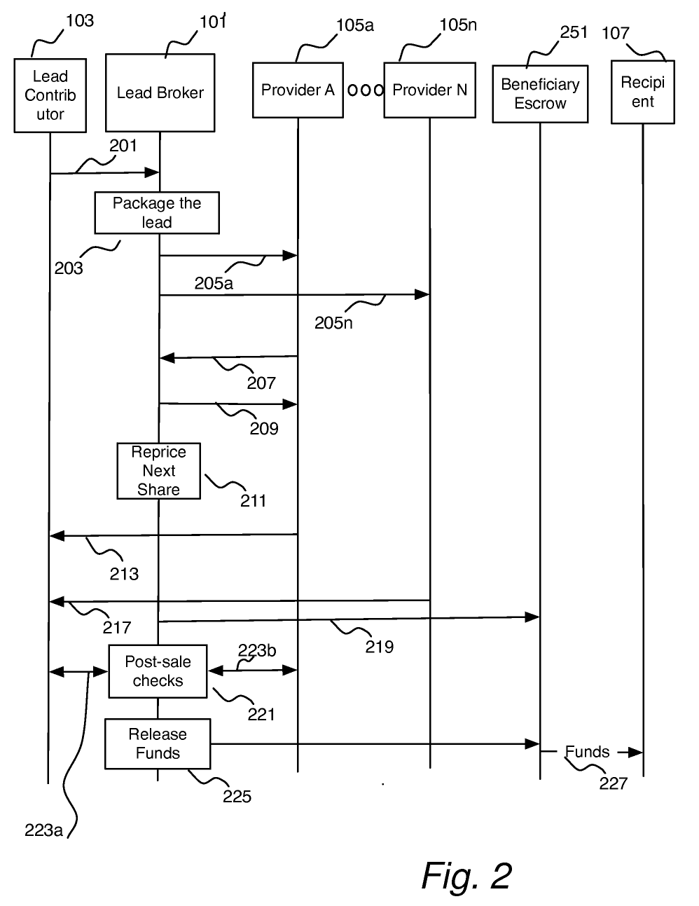

FIG. 2 is a high-level timing sequence diagram illustrating message flow between the lead contributor 103, the lead broker 101, potential providers 105, and the intended third-party recipient 107. When a lead contributor 103 wishes to obtain bids for an item or service, the lead contributor 103 enters that information with the lead broker system 101, message 201. The lead is repackaged to be suitable for transmission to potential providers 105a-105n, step 203. As is discussed in greater detail below, repackaging of the lead, in a preferred embodiment, entails making the lead anonymous to potential providers. The repackaged lead is then transmitted to potential providers 105, messages 205a-205n. Transmission of a repackaged lead to a potential provider 105 may be done in many different ways. For example, the repackaged lead may be transmitted to the potential provider 105 as an e-mail message or sent as an SMS (short message service) message to the potential provider 105.

Consider, as an example, that potential provider A 105a is the first potential provider 105 to decide to purchase a share in the lead. The potential provider A 105a may then indicate to the lead broker 101 the wish to purchase a share, message 207. This indication may also be done in several different ways. In a preferred embodiment, the lead broker 101 is implemented as a service provided using a web server (discussed in greater detail below). When receiving a message that there is a lead available for purchase, the potential provider 105 may sign in to the web site operated by the lead broker 101. In an alternative approach, the potential provider 105 purchases the share in the lead by sending an SMS.

The full detail of the lead (or at least sufficient detail so that the potential provider 105 can provide a bid against the lead) is then transmitted to the purchasing provider 105, message 209.

There are many different possible approaches to pricing shares in leads. One simple approach is flat-rate pricing, i.e., a share costs a fixed price that does not change. Another approach is a traditional auction, i.e., if n shares are to be sold, the n highest bids are allocated the shares. In one embodiment, described in greater detail below, prices for shares are set according to demand, referred to herein as the “Simulated Demand by Rate of Sale” approach to share pricing. Thus, after a share has been purchased, the lead broker 101 may set a new price for the next share, step 211. In yet another embodiment, also described in greater detail below and referred to as “Continuous Sealed Auction” shares are auctioned off in a series of blocks (a block is a set length of time) in each of which an auction for shares is held. At the conclusion of each block, the highest bids in that auction are awarded shares. If there are remaining shares to be sold, follow-on auctions are held in subsequent blocks until either all shares have been sold or the lead sale period has expired. In yet another alternative, the auctions held in the series of auction blocks are open-bid auctions.

The goal of the pricing method is to maximize price per share and to minimize the time required to sell a desired minimum number of shares (e.g., having a goal of selling minimum number of shares in half the period prior to expiry of the lead offer).

Having obtained the details of the lead, the potential provider A 105a issues a bid to provide the desired goods or services, message 213.

A similar exchange may take place with other potential providers 105 who have purchased shares in the lead whereby the lead contributor 103 obtains multiple offers for the desired goods or services, message 217.

The lead contributor 103 selects one of the potential providers 105 who presented a bid for entering into a contract for the desired goods or services outside of the lead broker system.

The portion of the sales proceeds slated for the third-party recipient 107 is placed in escrow 251, message 219.

The lead broker 101 performs post-sale checks to determine that there are no disputes surrounding the sale of the lead shares, step 221. This check may include obtaining feedback, interactions 223a and 223b, from the lead contributor 103 and the potential providers 105. If the post-sale checks indicate that a valid lead sale process has taken place, funds held in escrow are released, step 225, and the funds raised from the lead sale are transferred to the designated recipient 107, step 227.

The schematic illustrations of FIGS. 1 and 2 are both at a high-level. The details of preferred embodiments are described herein below. For example, the lead broker 101 is described in FIGS. 1 and 2 in a very abstract sense. In a preferred embodiment, the lead broker 101 is implemented as a web server on a network. The other entities involved in the message flow of FIG. 2 interact with the lead broker 101 web server over the network using network-connected computers executing web browsers. The message flow between these entities, in that embodiment, are web pages served from the web server and corresponding responses from the web browsers operated by the lead contributor 103 and the potential provider 105. In alternative embodiments, some of the exchange may be via SMS to mobile telephones over a mobile telephone network or even telephone calls placed over a landline-based telephone system.

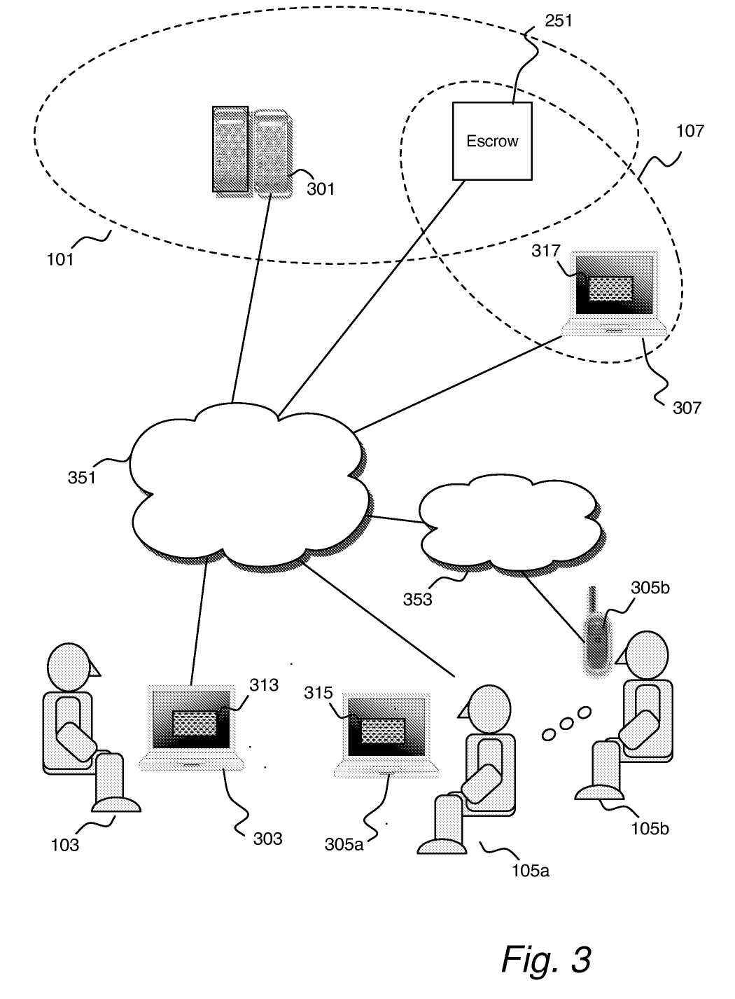

FIG. 3 is a schematic illustration of an operating environment in which the lead broker system of FIGS. 1 and 2 may operate. The lead broker 101 may consist of a web server computer 301. The lead broker web server computer 301 may be based on any standard web server camp, e.g., a computer running the Linux operating system and the Apache web server and the MySQL DBMS. To be accessible by other entities, e.g. lead contributors 103 and potential providers 105, the lead broker web server computer 301 is connected to a network 351, e.g. the Internet.

A lead contributor 103 operates a computer 303 that is also connected to the network 351. To connect to the lead broker 101, a lead contributor 103 uses a web browser 313 on the computer 303 to sign in to the lead broker 101. After signing in to the lead broker 101, a series of web pages, served from the lead broker computer 301 over the network 351, are displayed in the web browser 313 on the lead contributor's computer 303.

Potential providers 105 may be connected to the lead broker 101 over the network 351 either directly using a computer 305a or, as potential provider 105b illustrates, using a mobile telephone 305b over a mobile telephone network 353. Potential providers 105 may also connect to the lead broker computer 301 using a personal digital assistant over the network 351. The connections between the potential provider 105 and the lead broker101 may be using a web server/web client model wherein a web browser 315 displays one of a series of interactive web pages served from the lead broker web server computer 301. In an alternative, the “connection” is via e-mail or SMS messages transmitted between the lead broker 101 and the potential provider 105.

The fourth player in the system, the third-party recipient 107 designated by the lead contributor 103 to receive a portion of the proceeds from any lead share sales, may in part be an escrow account 251 managed by the lead broker 101. The third party recipient 107 may also have the ability to interact with the lead broker 101 through the lead broker's web server computer 301 over the network 351 using a computer 307, typically through a web browser 317. The third-party recipient 107 may want to interact with the lead broker 101 to check information such as moneys received from share sales and pending lead sales for which the third-party recipient 107 is a beneficiary.

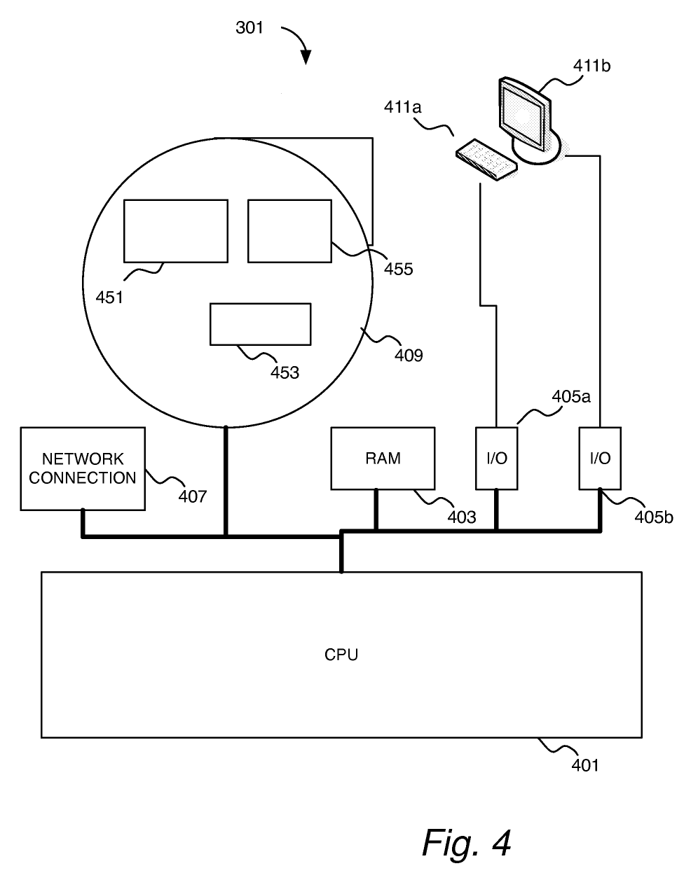

FIG. 4 is a schematic illustration of a lead broker computer web server computer 301. In a preferred embodiment, the lead broker computer web server computer 301 contains, for example, a central processing unit 401, a RAM 403, I/O interfaces (e.g., USB and DVI) 405a and b, a network connection 407 (e.g., WIFI, LAN), and secondary storage 409.

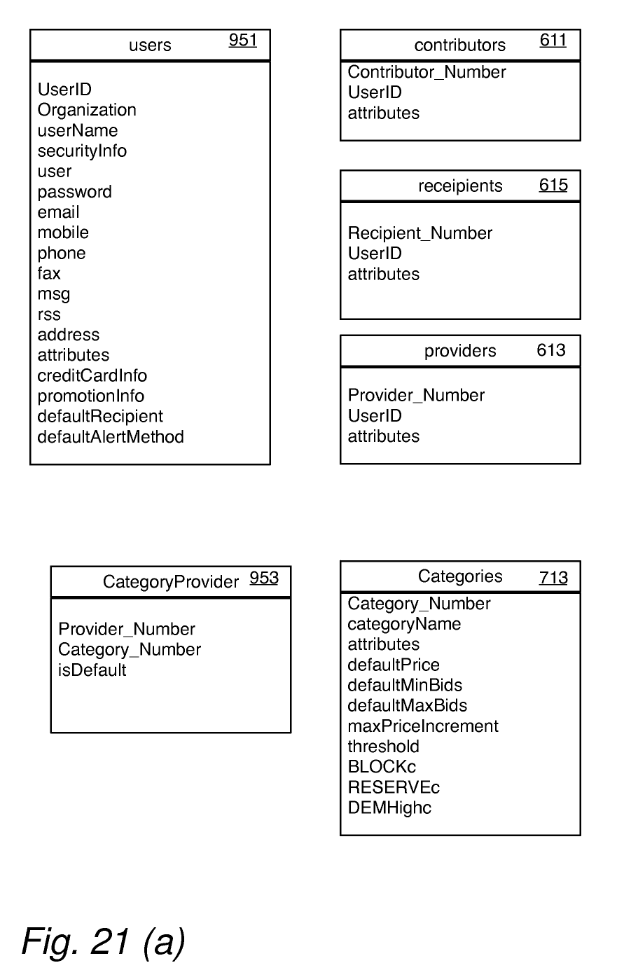

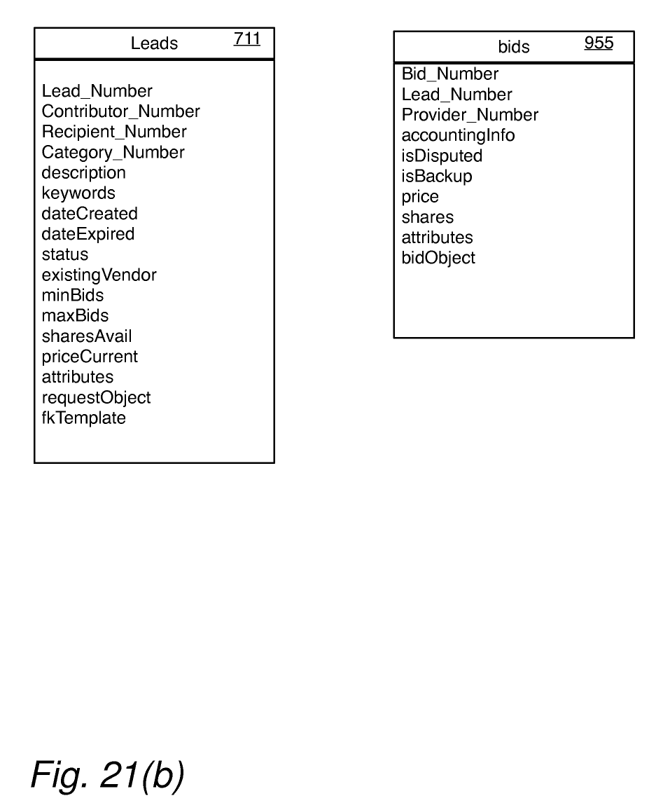

The secondary storage may contain software programs 451 (hereinafter referred to as the lead broker system 451) for controlling the operation of the lead broker web server computer 301 and may also contain one or more databases 453 for storing data pertinent to the operation of the lead broker web server computer 301 (one possible database schema, used herein as an example, is illustrated in FIG. 21). In a preferred embodiment, much of the interaction with the lead broker 101 is over the Web. Thus, to a large extent the lead broker system 451 consists of web pages served over the network 351. A web server 455, for example, the very popular Apache Web Server, is also stored in the secondary storage 409, and includes instructions to cause the CPU, via the network connection 407, to transmit web pages such as those from the lead broker system 451 to remote computers connected to the network 351.

An operator may intervene in the operation of the lead broker web server computer 301 or monitor the operation of the lead broker web server 301 through user interface devices 411a and b, e.g., keyboards and display devices. An operator may also interact with the lead broker web server computer 301 by remote access over the network.

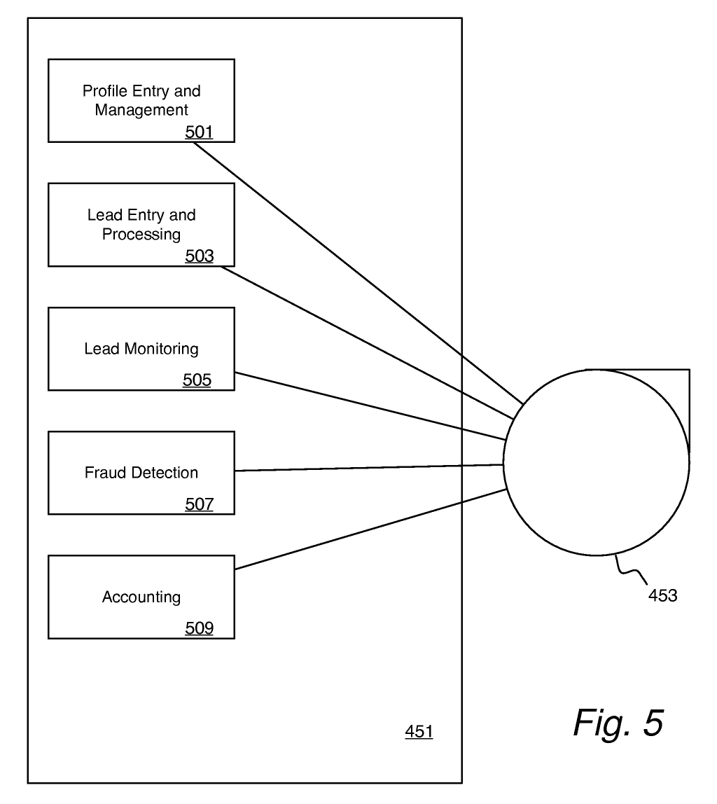

FIG. 5 is a block diagram illustrating major functional modules of the lead broker system 451. It must be understood that the precise division of functionality into the modules shown in FIG. 5 are for purposes of illustration and that the different ways in which the functionality of the lead broker 101 is partitioned into discrete modules is only limited by the imagination of persons seeking to implement such a system. Accordingly, the particular distribution of functionality over the modules as illustrated must not be construed to limit the invention.

The lead broker system 451 contains five major functional modules: Profile Entry and Management 501, Lead Entry and Processing 503, Lead Monitoring 505, Fraud Detection 507, and Accounting 509. Each of these modules interacts with data records stored in the lead broker databases 453.

Contributor Signup, Provider Signup, and Recipient Signup

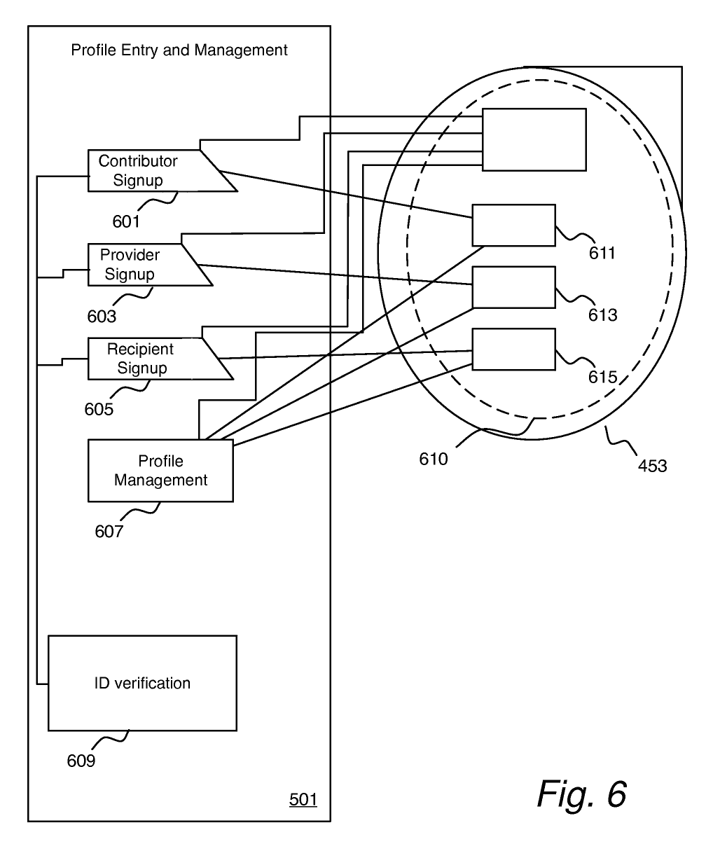

FIG. 6 is a block diagram illustrating the sub-modules of the Profile Entry and Management module 501 of the lead brokerage system 451 introduced in FIGS. 4 and 5. The lead brokerage system 451 provides mechanisms to sign up new users. There are at least three categories of users: lead contributors, potential providers, and third-party recipients. The lead brokerage system 451 contains a module for each such user: a contributor signup module 601, a provider signup module 603, and a recipient signup module 605.

Each of the signup modules 601, 603, and 605 may consist of a series of interactive web pages served to a browser or an end-user's computer, e.g., computers 303, 305, and 307, respectively. To signup for using the lead broker system 451a user enters information through a web browser, e.g., web browsers 313, 315, and 317, respectively. The users enter information such as username, name, e-mail address, physical address and password. This information is entered into a users database table 951, both generally and more specifically for tables corresponding to each type of user (contributor, provider, and recipient), e.g., a contributor table 611, a provider table 613, and a recipient table 615 (these tables are illustrated in greater detail in FIG. 21). As a person skilled in the art of database design will appreciate, these tables may be considered logical tables for purposes of explanation. In actual implementation these tables may instead be one table in which the role or roles associated with a user is a separate field. Again, the myriad of ways in which to organize the data is only limited by the imagination of the implementer; each such alternative must be considered to be within the scope of this invention.

In the example database schema of FIG. 21 (broken into partial views 21(a) and 21(b)) each user may take multiple roles. Thus, each of the contributors table 611, the recipients table 615, and the providers table 613 contains a list of the users that are signed up for those roles, respectively. Each contributor, recipient, and provider is assigned a Contributor_Number, Recipient_Number, and a Provider_Number, respectively. These numbers are used to identify the user in other tables in which the contributor, recipient, or provider is uniquely associated with a particular record.

The information that pertains to the individual users, such as username, password, addresses and telephone numbers, is stored in the users table 951.

The signup modules 601, 603, and 605 verify the identity of a user attempting to sign up to use the lead broker system 451. In one embodiment, each of the signup modules 601, 603, and 605 include data entry screens for entering identifying information, e.g. a credit card number. The signup modules 601, 603, and 605 call upon an identification verification module 609 to confirm the veracity of identifying information entered by the user. The identity verification may be performed by communicating over the network with a server, e.g., a credit card company, who can confirm the validity of the information. In order to reduce invalid and duplicate signups, an e-mail verification system may also be employed. After the user has entered his information during signup, a verification e-mail is generated and sent to the e-mail address entered by the user. Before an account will be activated, the user must validate his identity by either return e-mail or following a link to a verification web page to complete the verification process. This verification process is part of a fraud prevention mechanisms within the system.

By using subdomains and special URLs (i.e. www*worthybids*com/unitedway)¹ for the signup web pages, the lead broker system 451 may track the originator of signup requests, i.e., particular third-party recipients who may work to encourage users to sign up may have associated therewith particular unique subdomains. For example, if the main url of a lead broker 101 is www*worthybids*com, new users that are referred by the United Way may use the url unitedway*worthybids*com. Such affiliations are referred to herein as lead brokerage networks. In conformity with 37 CFR 1.57(d) which prohibits use of executable hyperlinks in patent documents, this document uses asterisks in lieu of periods in example hyperlinks. In actual practice, these asterisks would, of course, be periods.

While the signup modules 601, 603, and 605 may be unique with respect to each type of user (lead contributor 103, potential provider 105, third-party recipient 107), once signed up, a user may add roles to that user's profile; i.e., a lead contributor 103 may also be a potential provider 105.

Exemplary database tables for storing user information may include the following information:
Type of user—Recipient, Provider, Contributor
Identity and contact information—for example, name, company, address, e-mail address, phone
Billing information—for example, credit card data, pricing/discount information/eligibility
System preferences—for example, default third party recipient and securely stored billing information (i.e. credit card information) for repeat users.
Membership relationships—may include, but not be limited to, the lead circle to which the user belongs and the lead brokerage network to which the user belongs. Such membership relationships may affect pricing, enable discounts, and/or modify accounting methods, for example.
Provider specific preferences—for example, how leads are transmitted (e-mail, sms, rss, etc.), and parameters defining the types of leads that the provider is interested in receiving
Recipient specific info—for example, how to send funds to recipient and special requirements
Notes—for example, operator-entered notes regarding a user's use of the lead brokerage system 451 such as support logs

Certain pieces of information stored in the user databases are intended for the administration of the lead brokerage system 451 and not for the direct use of users. For example, a user's Internet Protocol (IP) address of the computer 303, 305, 307 they are utilizing to access the lead brokerage system 451 or the type, version and capabilities of the user's web browsers 313, 315, and 317.

Profile Management Module 607

The profile management module 607 provides mechanisms by which a user may edit, update and delete information stored in the user database tables 951, 611, 613, and 615 (collectively the profile tables 610). When an existing user or administrator signs in to the lead broker system 451 through a landing page the user or administrator is presented several options. One such option is “profile management.” By selecting that option, the user would be presented with one or more web pages for viewing and editing information in the appropriate user database tables 951, 611, 613, or 615 (collectively 610).

Lead Entry and Processing 503

The core of the lead broker system 451 is the entry, processing and sale of leads. In a preferred embodiment, upon signing in to the lead broker system 451 a lead-contributor user 103 is presented with an option to create a new lead. If selecting that option, the web server of the lead brokerage web server computer 301 transmits a lead entry web page over the network to the computer 303 of the lead contributor 103.

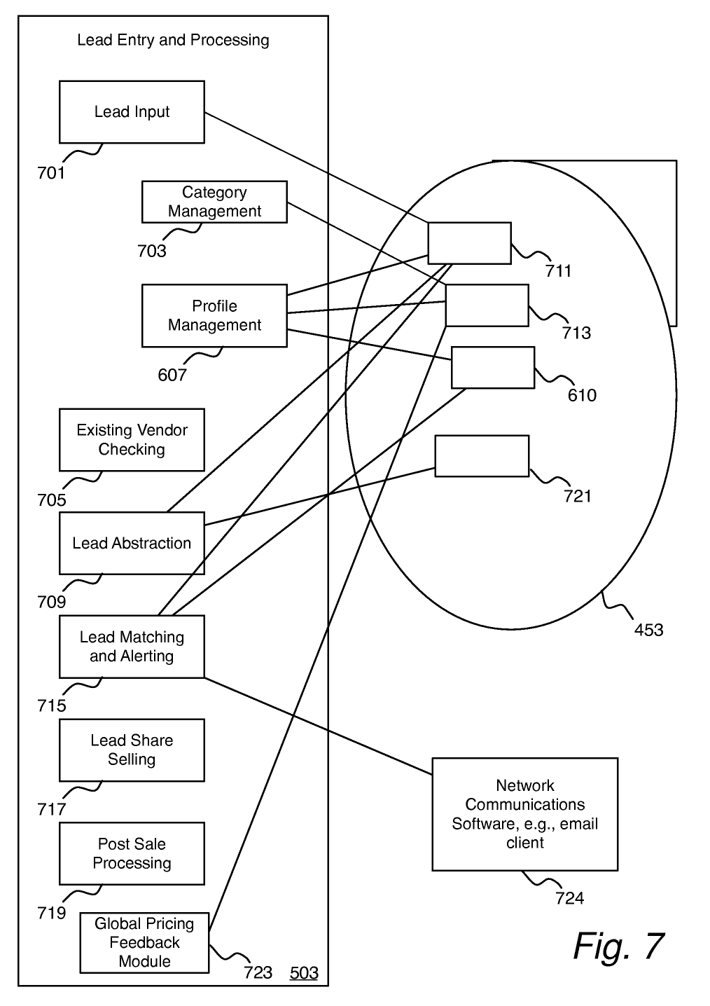

FIG. 7 is a block diagram illustrating the sub-modules of the lead entry and processing module 503. Lead entry and processing 503, in one embodiment, is made up of several sub-modules, including a lead input module 701, a category management module 703, a profile management module 607, an existing vendor check module 705, a lead abstraction module 709, a lead matching and alerting module 715, a lead share selling module 717, and a post-sale processing module 719. The pricing of shares is adjusted periodically. In one aspect the overall price achieved for share sales within a category of leads is used to price new leads entered in that category. A global pricing feedback module 723 provides this functionality. Each of these modules is described in greater detail herein below.

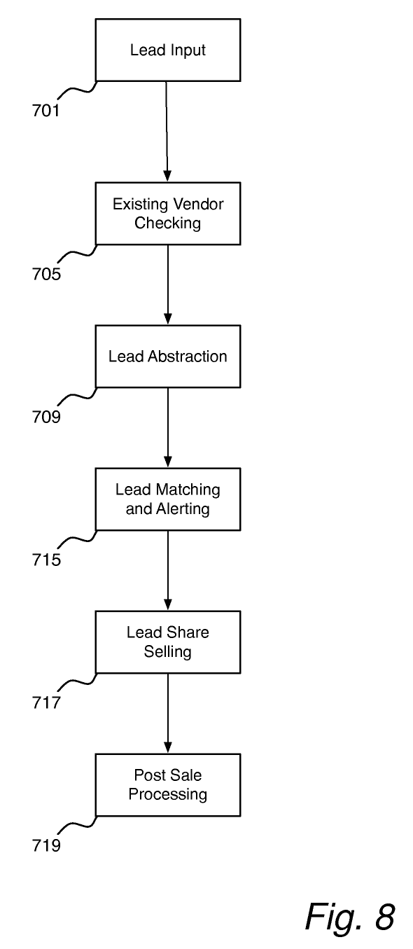

FIG. 8 is a high-level workflow diagram of the lead entry and processing module 503. A lead is contributed by a lead contributor 103 using the lead input module 701. Processing is then transferred to the existing provider checking module 705 for determining whether any potential provider 105 is an existing provider to the lead contributor 103 in which case it may not be appropriate to market the lead to that existing provider.

Next, the lead is abstracted by the lead abstraction module 709. To provide a potential market for a lead, the lead contributor 103 cannot be identified when the lead is presented to potential providers 105. The lead abstraction module 709 thus makes the lead contributor anonymous prior to the lead broker system 451 presenting the lead to the potential providers 105.

Next, the lead is matched to the users of the system who are registered to receive leads to identify the potential providers 105 for the desired goods or services by the lead matching and alerting module 715. The abstracted lead is next presented by the lead matching and alerting module 715 to the identified potential providers 105 or a subset of the identified potential providers 105.

Shares in the lead are sold by the lead share selling module 717 as requested by the potential providers 105.

Required post-sale activity is marshaled by the post-sale processing module 719.

Each of the activities of the sub-modules of the lead entry and processing module 503 that affect lead entry and processing are described herein below. It should be noted that the transitions in the workflow of FIG. 8 may be implemented in many different ways. In one embodiment the modules are separate parts of one functional program in which the processing of a lead is implemented by calling different parts of that functional program. In another embodiment, the modules exist as separate computer processes existing in the computer operating system and the processing of a lead may be implemented by communicating messages between these processes. In another embodiment, leads are placed in different buffers that the various processes either produce or consume. For example, the lead input module 701 may create a buffer of leads that have not been abstracted; the lead abstraction module 709 would consume that buffer and produce a buffer of abstracted leads which the lead matching and alerting module 715 may consume, and so on.

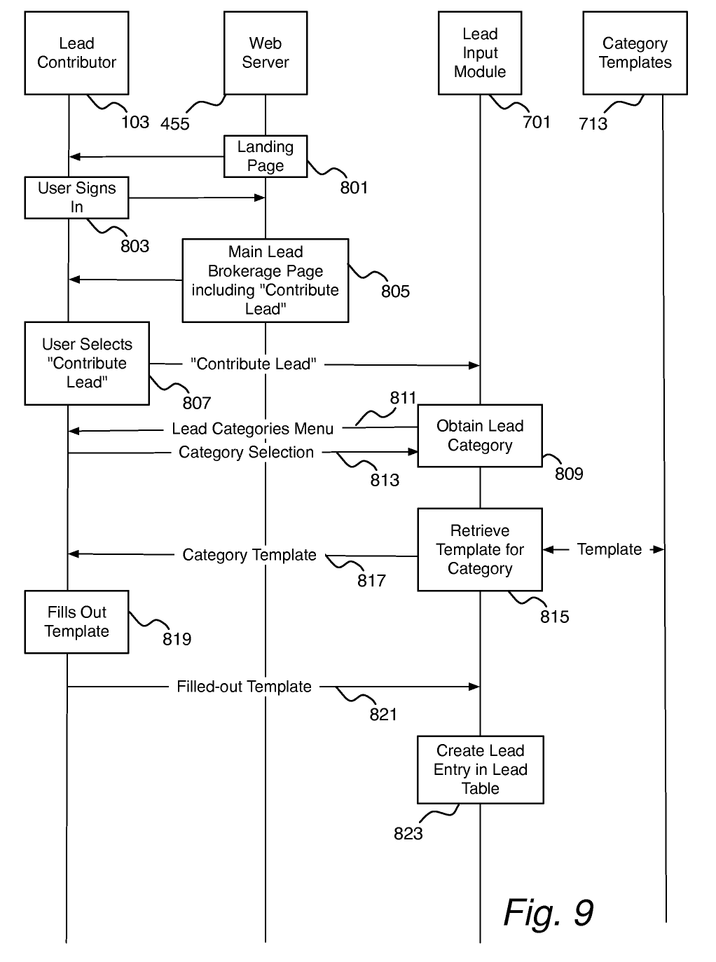

A lead input module 701 performs interaction between a lead contributor 103 and the lead broker system 451. FIG. 9 is a timing sequence diagram illustrating the operations performed by lead broker system 451 in response to a lead contributor 103 contributing a lead using the lead input module 701. When a user has navigated the Web to the lead broker landing page (or a landing page for a related subdomain), the web server 455 transmits the lead broker landing page 801 to the user's computer over the network 351. The lead broker landing page 801 contains a mechanism for a user to sign in to the lead broker system 451.

User in the preceding and next paragraphs refers to any person navigating to the lead brokerage system 451 over the Web. There are at least four types of registered users: administrators, lead contributors, providers of goods and services, and third-party recipients. Thus, the particular user involved in the creation of a lead is a lead contributor 103. However, the lead brokerage system 451 would not know which category of user the individual interacting with the lead brokerage system 451 is until the user starts interacting with the web pages presented to the user.

When the user has signed in, step 803, the lead broker system 451 transmits a main lead brokerage web page 805 containing an option for contributing a lead. If the user selects the “contribute lead” option and thereby takes on the role of a lead contributor 103, step 807, the lead input module 701 is invoked. The lead input module 701 consists of a collection of web pages and corresponding functional program code. An initial selection requested from the lead contributor 103 is the selection of a lead category, step 809. Thus, the lead input module 701 transmits a web page for indicating lead category, e.g. a selection menu, via the web server 455, to the computer 303 of the lead contributor 103, step 811. The lead category selection of the lead contributor 103 is transmitted back to the lead input module 701, step 813.

As illustrated in FIG. 7, lead categories are managed by a lead category management module 703. The lead category management module 703 is connected to a lead category database table 713 for storing lead categories and related information. The lead category management module 703 provides lead entry templates to a user, typically a lead broker system 451 administrator, for adding, editing, removing, and sub-categorizing lead categories. The lead category management module 703 may also include a mechanism for a lead contributor 103 to suggest new categories.

An example of the lead category database table 713 is illustrated in FIG. 21 a. Each category is provided with a Category Number uniquely associated with a particular category or subcategory. In one embodiment, two levels of categories are provided for: major category and sub-category. In that simple case, table 713 may be broken up into dedicated tables for each of these levels. Table 713 illustrates a generalization in which multiple levels of categories are possible.

Some example lead categories and sub-categories include Real Estate (major category), Office Leases (sub-category), Office Equipment (major category), Copiers (sub-category). In a generalized system the Copiers category may be further refined into, for example, commercial copiers and small office/home copiers. Alternatively, the latter is simply handled through an attributes list. For purposes of illustration, the embodiment including a major category and one level of sub-categories is described herein.

Lead categories are used to match leads entered by the lead contributor 103 to potential providers 105. Therefore, in a preferred embodiment, lead contributors 103 are requested to select already existing categories, as any new categories can, by definition, not have any potential providers 105 as subscribers. However, if a lead contributor 103 wishes to provide a lead for a truly new category that hitherto has not been serviced by the lead broker system 451, the lead contributor 103 may suggest a new category and thereby place the burden of contacting potential providers 105 that may service such a lead category on the administrator of the lead broker system 451.

Lead categories are also used to provide different pricing models for the purchase of lead shares. This feature is desirable because the value of leads vary from category to category. For example, the value of a lead for a large office space where the rent may be thousands of dollars per month would be very different from the value of a lead for a one-time purchase of a simple copier.

Lead categories and lead entry templates associated with each category are also useful to allow for customization of the information collected with respect to a lead in the lead input module 701. For example, for real estate, the collected information would typically include features such as square footage, location, and class of space, whereas for office equipment, such as a copier, the information may be specification features such as black-and-white versus color, copy volume, or networkability. The salability of a lead is commensurate with the quality of the information given about the desired goods or services. Therefore, it is valuable to provide templates to a lead contributor 103 requesting the most thorough information possible for particular leads.

Returning briefly to FIG. 6, the provider signup module 603 and profile management module 607 provide mechanisms by which a provider may be associated with particular categories of goods and services. For example, an office equipment vendor may sign up for the major category office equipment and sub-categories for copiers and coffee-service equipment. The association between a provider and categories is managed in a CategoryProvider table 953 illustrated in FIG. 21a.

Returning now to FIG. 9, when the lead input module 701 has obtained the lead category, step 809, the appropriate lead entry template is obtained, step 815. The appropriate template is then transmitted to the lead contributor 103 via the web server 455, step 817.

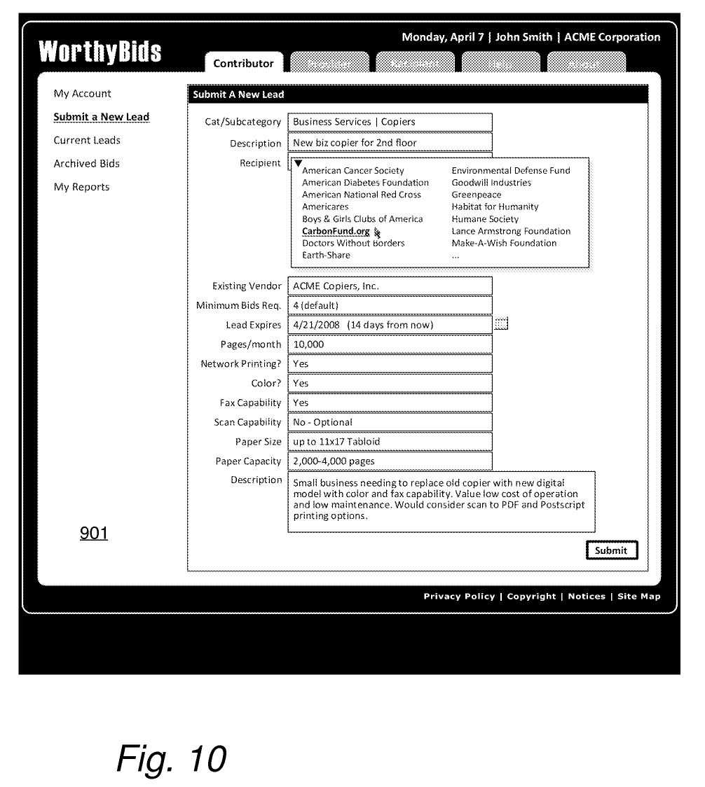

FIG. 10 is an illustrative lead input template 901 provided to a lead contributor 103 and displayed in a browser window 313 on the computer 303 of the lead contributor 103. The lead template may include fields for entering the minimum number of bids requested, the designated third-party recipient 107, an expiration date for the sale of shares, and special restrictions such as only local providers may buy shares in the lead.

Category-specific templates have specific fields pertinent to the particular category of the lead and particular sub-category. For example, if the category is copiers, there may be fields such as number of copies per minute, color or black-and-white or networkability.

There may also be user-category specific fields. Lead contributors 103 may be categorized by affiliation. For example, a lead contributor 103 who is a member of a particular lead broker group (e.g., a chamber of commerce) may have its lead restricted to other members of the same lead circle. In one embodiment, the option could be provided to specify that if such restricted leads remain unsold, the lead would be made available outside of the particular lead broker group.

The lead broker system 451 may detect what type of browser the lead contributor 103 is using and tailor the templates accordingly. For example, if the lead contributor 103 is connected to the lead broker system 451 via a mobile device such as a PDA or a smart phone, the template may be formatted suitably.

The lead contributor 103 fills out the template 901, step 819, and the filled-in template—or more accurately the values associated with the fields filled-in on the template—are transmitted to the lead input module 701, message 821.

When the lead template message 821 has been received by the lead input module 701, the lead input module 701 creates an entry for the lead in a lead table 711 in the lead broker database 453, step 823. There are many different possible embodiments of the lead broker database 453. In one embodiment, the lead broker database 453 is a relational database with a table for storing active leads, a table for storing shares purchased in an active lead, and a fields table for storing field specific data for each active lead, and so forth. In another embodiment, the lead broker database 453 is organized as an object-oriented database with a lead class under which each category and subcategory are subclasses and wherein each lead is an instantiation of the appropriate subcategory class.

An example lead table 711 is illustrated in the database schema of FIG. 21b. As illustrated there each lead record is defined by a unique Lead_Number and has associated therewith a Contributor_Number indicating the lead contributor 103 of the lead, and Recipient_Number identifying the intended recipient of proceeds from sales of shares in the lead.

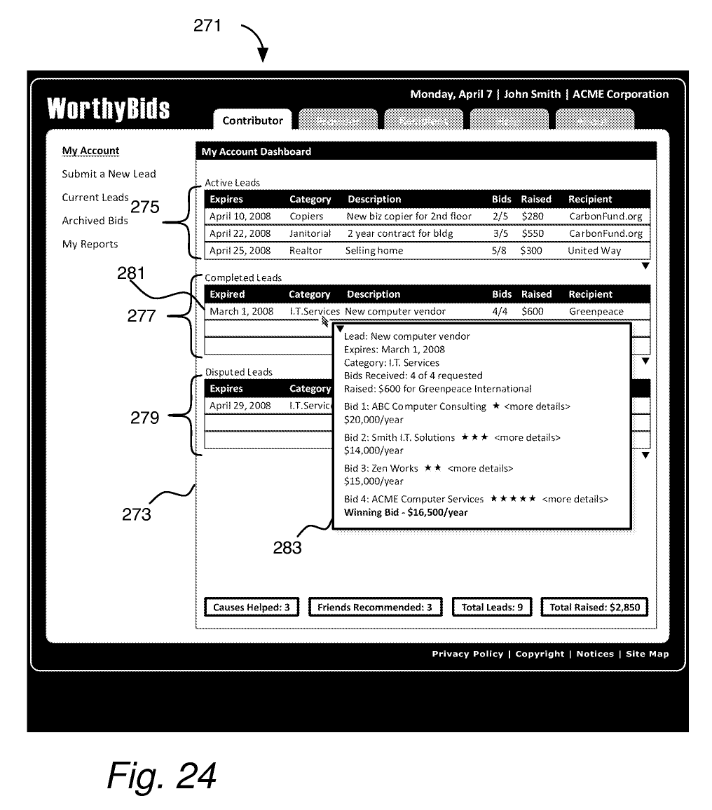

Each user registered to use the lead brokerage system 451 is presented with a customized portal webpage after successfully signing in to the lead brokerage system 451. That portal page for a lead contributor 103 may contain a dashboard providing, e.g., status information with respect to active leads that have been contributed by a lead contributor 103. FIG. 24 is an example screen shot of a portal page 271 for a lead contributor 103 including a dashboard 273. The dashboard provides lists for active leads 275, completed leads 277, and disputed leads 279. An active lead is a lead that has been submitted, having an expiration time that has not yet expired, and for which shares are still available for purchase. The entries for active leads may include an indication of how many bids have been sold out of a total number of available bids and provide feed back for the lead contributor 103 in regard to how much money has been raised-to-date on a particular lead. A completed lead is a lead for which the sale of shares has been closed. Share sales close either on the expiration of the lead or when all shares in the lead have been sold. A disputed lead is a lead for which there is a dispute that stands in the way of releasing funds to the recipient 107 associated with the lead, for example, a potential provider 105 had purchased a share and later discovered that there was a reason for which the potential provider 105 should not have to pay for the lead.

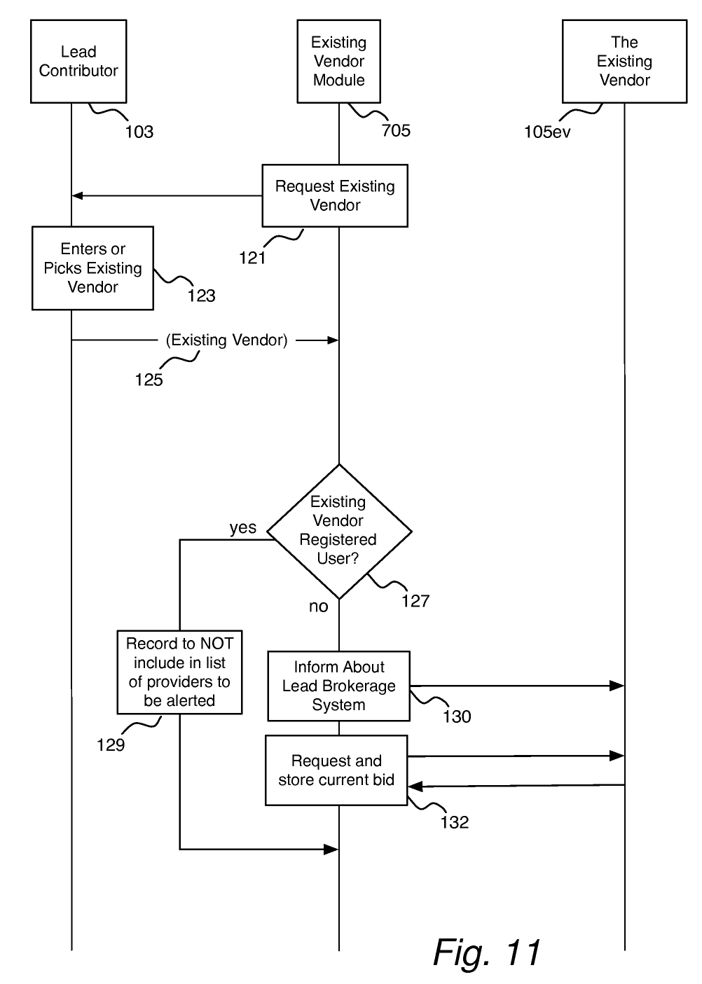

As illustrated in FIG. 8 after a lead contributor 103 has created a lead, the workflow in processing the lead passes to the existing vendor checking module 705. FIG. 11 is a timing sequence diagram illustrating message flow and processing performed by the existing vendor checking module 705.

When the work flow of FIG. 8 passes a lead onto the existing vendor checking module 705 the existing vendor checking module 705 requests the lead contributor 103 to enter the current vendor that the lead contributor 103 uses for the desired goods or services, step 121. The existing vendor request (step 121) may either be as part of a lead input module 701 template or as a separate follow-up page presented to the lead contributor 103 after other lead input module 701 templates have been received. As the lead broker system 451 maintains a list of providers of goods and services, that list may be presented to the lead contributor 103 and the lead contributor 103 may select one of these providers. If there is an existing vendor and if the existing vendor is not in the list of providers maintained by the lead broker system 451, the lead contributor 103 may then enter the existing vendor in some other fashion, e.g., by filling out information about the vendor in fields in a template for that purpose. The existence and identity of the existing vendor is transmitted back to the existing vendor checking module 705, message 125.

If the entered existing vendor is a registered user of the lead broker system 451, step 127, the existing vendor module 705 makes a record of the existing vendor as a provider that is not to be alerted about the lead, step 129. On the other hand, if the existing vendor is not a registered user of the lead broker system 451, step 127, the lead broker system 451 may inform the existing vendor 105ev about the lead broker system 451 and invite the existing vendor 105ev to register as a potential provider that may purchase shares in leads, for example, by transmitting an e-mail message to the existing vendor 105ev, step 130. The existing vendor module 705 may also request the existing vendor 105ev to respond with its current bid for the desired goods or services and if the existing vendor 105ev does respond with the current bid, step 132, that bid may be stored by the existing vendor module 705 to be used in downstream processing for comparison purposes.

The next module in the workflow of FIG. 8 is the lead abstraction module 709. To ensure a market for lead shares it is useful to hide certain information from the potential providers 105 to which the lead is marketed; otherwise a potential provider 105 receiving an alert for a lead may deduce the lead contributor 103 and bypass the lead broker system 451.

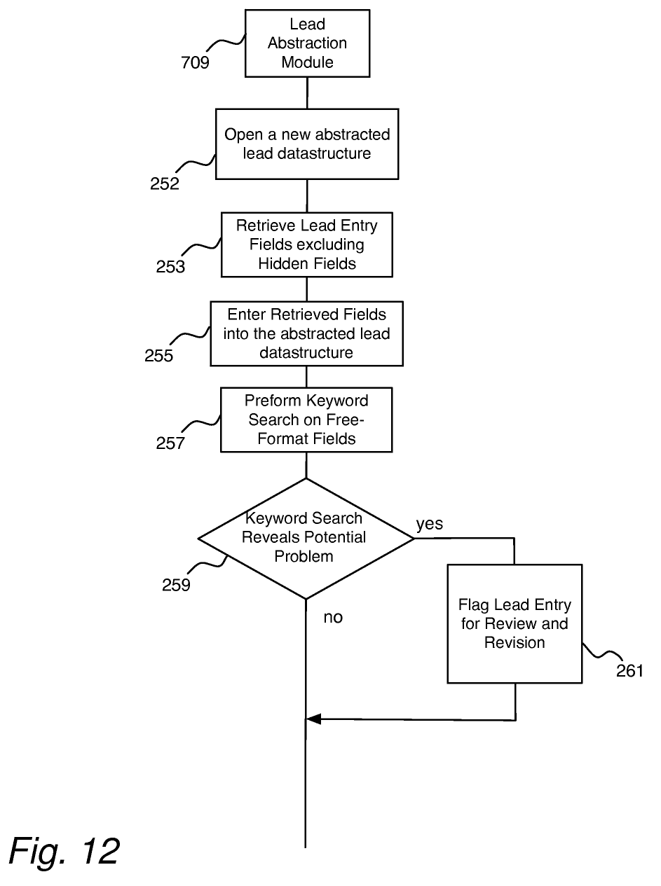

FIG. 12 is a flowchart illustrating the operations of the lead abstraction module 709. The lead abstraction module 709 produces a data structure, e.g., a text file, that may be transmitted to potential providers 105 registered to receive lead alerts for leads in the category to which the lead belongs, depicted in FIG. 7 as a lead alert data structure 721, step 252. In producing the abstracted lead data structure the lead abstraction module 709 uses fields from the lead input module 701 templates for the lead category of the lead, e.g., by extracting those fields from the lead entry in the lead data-structure 711, step 253. However, each lead category contains particular fields in the corresponding input template, and consequently in the stored lead entry, which are hidden and thus are not forwarded in the lead alert. Thus, the lead abstraction module 709 excludes the hidden fields when producing the lead alert data structure 721. The lead abstraction module 709 enters the retrieved fields into the lead alert data structure, step 255.

Furthermore, in one embodiment, the lead abstraction module 709 performs a keyword analysis on any free-format fields in the lead entry, step 257, for example, on fields for entering notes, to ensure that such free-format text cannot be used to deduce that the lead contributor 103 from the lead alert. If the keyword search unearths any potential problems with the free-format text, step 259, the lead may be flagged for manual review and revision, step 261. The keyword search searches for strings that could be used in addresses, telephone numbers, zip codes and e-mail addresses, e.g., words such as avenue, street, five digit numbers corresponding to any known zip codes or the “@” sign followed by a domain name. Depending on the problems revealed, the lead may be rejected for editing by the lead contributor 103 or the reviewer, e.g., an operator of the lead brokerage system 451 having administrative privileges, may perform the required edits.

The next module in the workflow of FIG. 8 is the lead matching and alerting module 715. The lead matching and alerting module 715 transmits the lead alert data structure 721 to appropriate potential providers 105, for example, by sending an e-mail message using system networking software 724, e.g., an e-mail client.

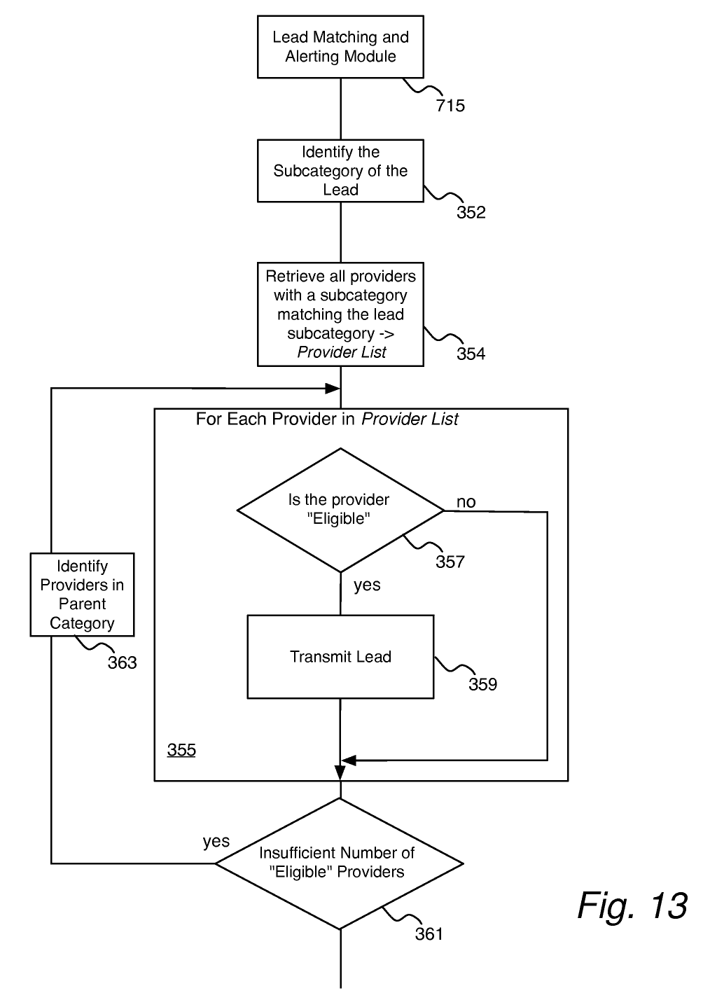

FIG. 13 is a flowchart illustrating the operations and dataflow of the lead matching and alerting module 715. The lead matching and alerting module 715 identifies the subcategory of the lead, step 352. Next the lead matching and alerting module 715 retrieves all the providers that subscribe to alerts for that category, step 354. For each provider identified (Provider List), loop 355, the lead matching and alerting module 715 determines whether the provider is eligible to receive the lead alert, step 357. If the provider is eligible, the lead matching and alerting module 715 transmits the abstracted lead, e.g., in the form of the abstracted lead data structure 721, step 359. “Eligibility” may depend on a number of factors. In one embodiment, lead contributors 103 and potential providers 105 may belong to particular lead circles having a requirement that leads are first provided to members of the lead circle. Thus, the eligibility test may include checking whether there is such an association or whether there are a sufficient number of providers in the lead category to satisfy the minimum number of providers who are to be alerted of the lead. Eligibility determination also includes checking whether the provider is an existing vendor of the lead contributor 103 as determined by the existing vendor module 705.

If there are not a sufficient number of providers in a subcategory, decision 361, the lead may be transmitted to providers in the parent category of the lead category, step 363. For example, if the lead is for a new copier, the sub-category may be Copiers and the parent category may be Office Equipment. If there are too few copier providers the lead may also be transmitted to the Office Equipment providers. In one embodiment there is no theoretical limit on the hierarchy of categories and sub-categories. In a preferred embodiment, the number of levels may be limited.

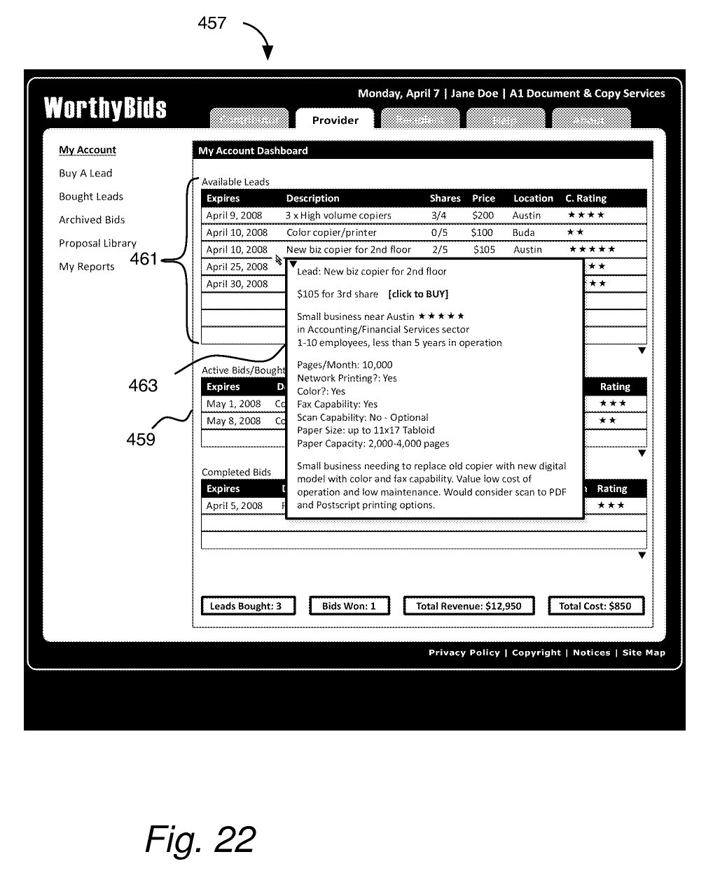

The transmission step 359 may include determining the methods by which lead alerts are transmitted to potential providers 105. When a user of the lead broker system 451 signs on to the lead broker system 451, the user is presented with a portal to the lead broker system 451 that is customized to that user. That portal page may include a dashboard or a dashboard for the user may be provided as a separate web page customized for the user. FIG. 22 is an example custom portal 457 showing the dashboard 459 for a provider 105. The dashboard contains the current status of the objects of the lead broker system 45 1which are of concern to the particular user. Thus, a potential provider 105 may see in the dashboard of the potential provider 105 a list 461 of leads for which the potential provider 105 is currently eligible to purchase shares. Clicking on a particular lead listed in the list 461 brings up a detail window 463 that provides the details describing the abstracted lead. The portal 457 may also provide other feedback to the provider 105 such as number of leads bought, bids won, and accounting information such as revenue raised through the lead brokerage system 451 and the total cost of bids purchased.

The potential provider 105 may also sign up to receive lead alerts via e-mail, telephone, SMS, or fed via RSS into an RSS reader, e.g., the Google home page of the potential provider 105 or another RSS client program. Potential providers 105 may also sign up to receive regular reminders of currently open leads, leads for which the potential provider 105 has purchased a share, leads that are soon to expire, etc.

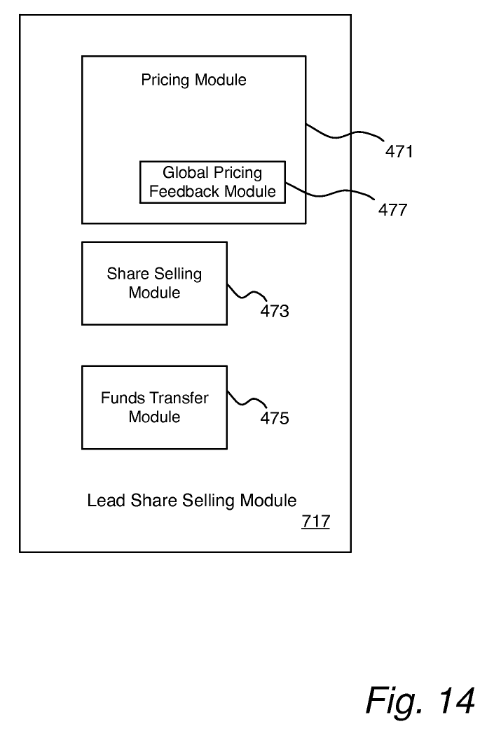

The next module on the workflow of FIG. 8 is the lead share selling module 717. The lead share selling module 717 handles all aspects of selling shares in a lead to one or more potential providers 105. In one embodiment, to accommodate these different functions of lead share sales, the lead share selling module 717 is divided into a pricing module 471, a share selling module 473, and a funds transfer module 475 as illustrated in FIG. 14. The pricing module 471 may further include a global pricing feedback module 477 for adjusting initial share prices as is discussed in greater detail herein below.

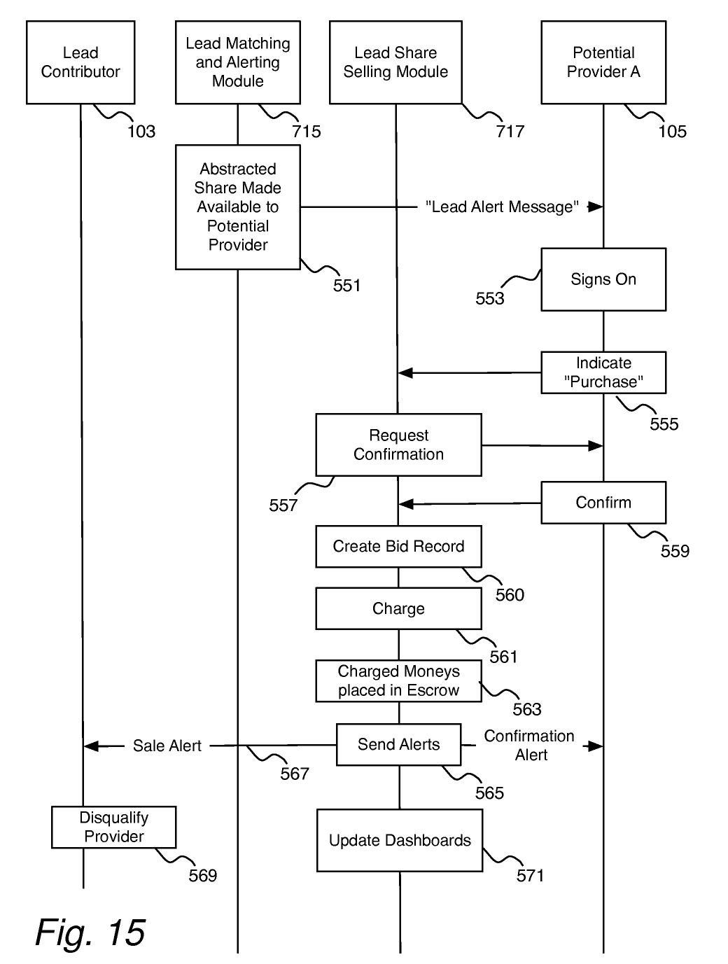

FIG. 15 is a timing-sequence diagram illustrating the processing and message flow of the lead share selling module 717. As discussed hereinabove, at this stage the lead has been abstracted by the lead abstraction module 709 and potential providers 105 have been identified and alerted of the availability of the lead by the lead matching and alerting module 715, step 551.

The potential provider 105 signs on to the lead broker system 451 to see the details of the abstracted lead on the dashboard of the potential provider 105, step 553. In one embodiment (Simulated Demand by Rate of Sale), the dashboard details the current price for a share, the current number of shares available, the maximum number of shares the potential provider 105 may purchase, and the abstracted details of the lead. In an alternative embodiment, used in conjunction with the Continuous Sealed Auction share pricing approach, the dashboard provides information about current auctions for shares to leads available to the potential provider 105 (other share-pricing options are possible alternatives, e.g., fixed share price or conventional auctions). The potential providers 105 may be allowed to buy multiple shares of a single lead. Much like shares in the stock market, buying multiple shares of a lead gives the potential provider 105 a larger market share and limits competitors, as long as the minimum number of bids is not jeopardized, from buying into the lead.

If the potential provider 105 decides to purchase one or more shares in a lead, the potential provider 105 indicates that purchase, for example, by clicking on an icon for that purpose on the dashboard, step 555.

The lead share selling module 717 may request a confirmation from the potential provider 105 that the potential provider 105 wishes to buy one or more shares in the lead, step 557, by causing transmission of a confirmation web page to the potential provider 105 and waiting for a limited period of time for the potential provider 105 to confirm the purchase of the share, step 559.

After the sale confirmation handshake has verified that the potential provider 105 wishes to purchase a share, a new bid is created in the database 453, step 560. The purchases of shares is managed by the lead share selling module 717 in a bids table 955. Each entry in the bids table 955 is assigned a unique Bid_number and is associated with a lead entry in the leads table 711 using the Lead_Number field.

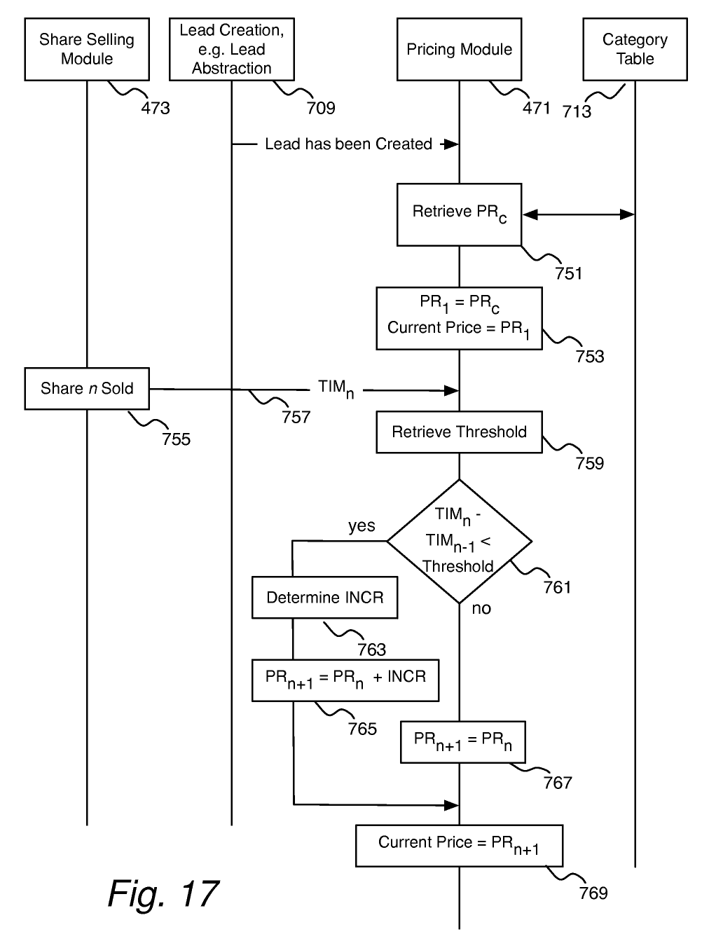

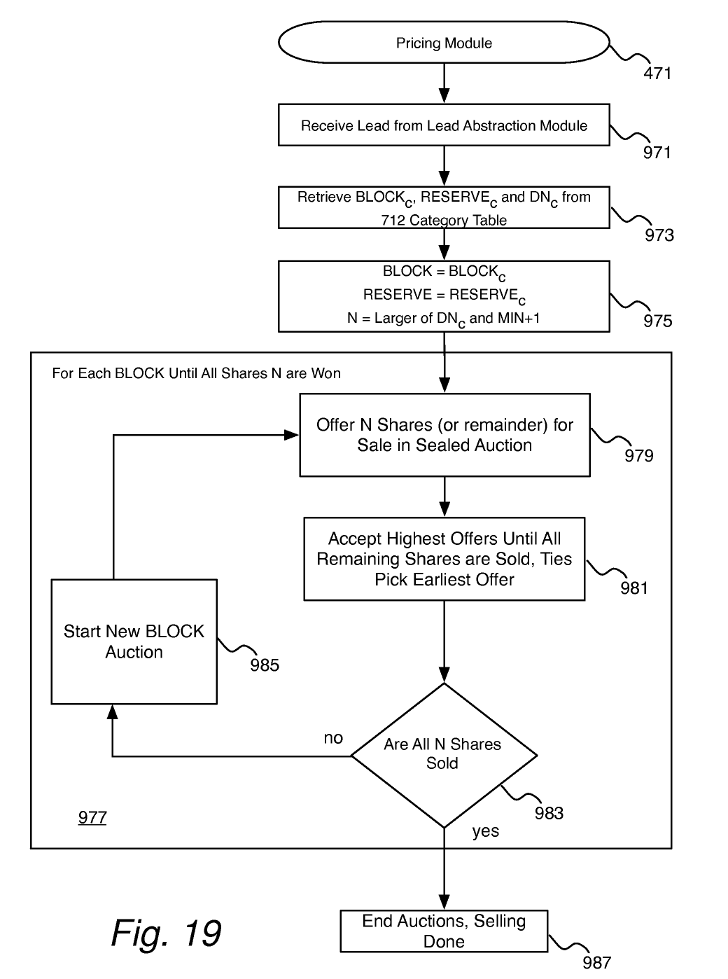

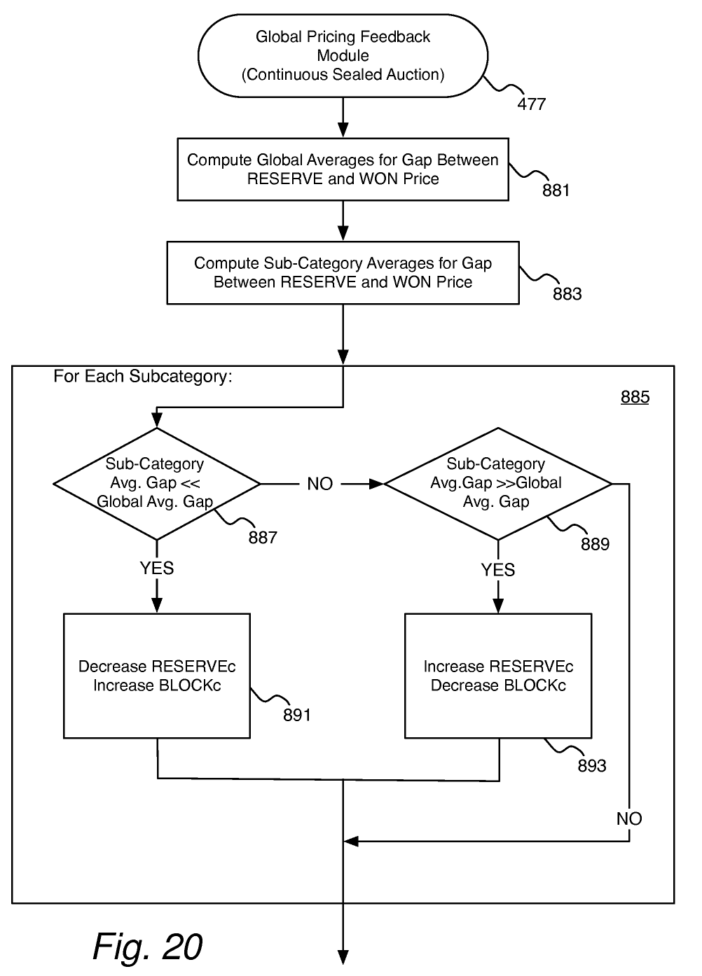

The confirmation message from the lead share selling module 717, step 557, may include an updated share price as other share purchases may have occurred between the original display of share price to the potential provider 105 and the purchase indication entry by the potential provider 105. As discussed herein below in conjunction with FIG. 17, the price for shares may be dynamic and, in one embodiment, depends on the rate at which shares are purchased, and as is illustrated in FIG. 19, in an alternate embodiment, depends on demand in a modified sealed auction, illustrated for example in FIG. 20. Thus, any purchase activity that occurs in parallel with a potential provider's 105 purchasing session may affect the share price. Furthermore, because there are limited numbers of shares in leads to be sold, other purchases may have removed the eligibility of the potential provider 105 to purchase shares.

If the potential provider 105 confirms the purchase of a share, step 559, the payment system, e.g., credit card, of the potential provider 105 is charged, step 561. Collected funds are held in escrow 251, step 563. Note that in a Continuous Sealed Auction sale of lead shares, the charge for the share is only performed after the potential provider 105 wins an auction block.

In some embodiments, at the point at which all available shares have been sold, the potential provider 105 may be offered the opportunity to purchase a backup share. The number of backup shares to be sold is also a parameter that is either provided as a system default or that the lead contributor 103 provides to the lead input module 701 when contributing the lead.

A confirmation alert is transmitted to the potential provider 105, step 565, and a sale alert is transmitted to the lead contributor 103, step 567. Finally, all relevant dashboards, e.g., the dashboard for each potential provider 105 who has purchased shares in the lead, the dashboard for the lead contributor 103, and the dashboard for the intended third-party recipient 107, are updated, step 571. In the example of dashboard 271 on FIG. 24, the completed leads list 277 contains a lead 281 for IT Services. All shares in the IT Services lead 281 have been sold. When the user moves a cursor over that lead entry in the dashboard 273, the user interface displays a detail window 283 that provides details about the various providers 105 that have purchased shares in the lead.

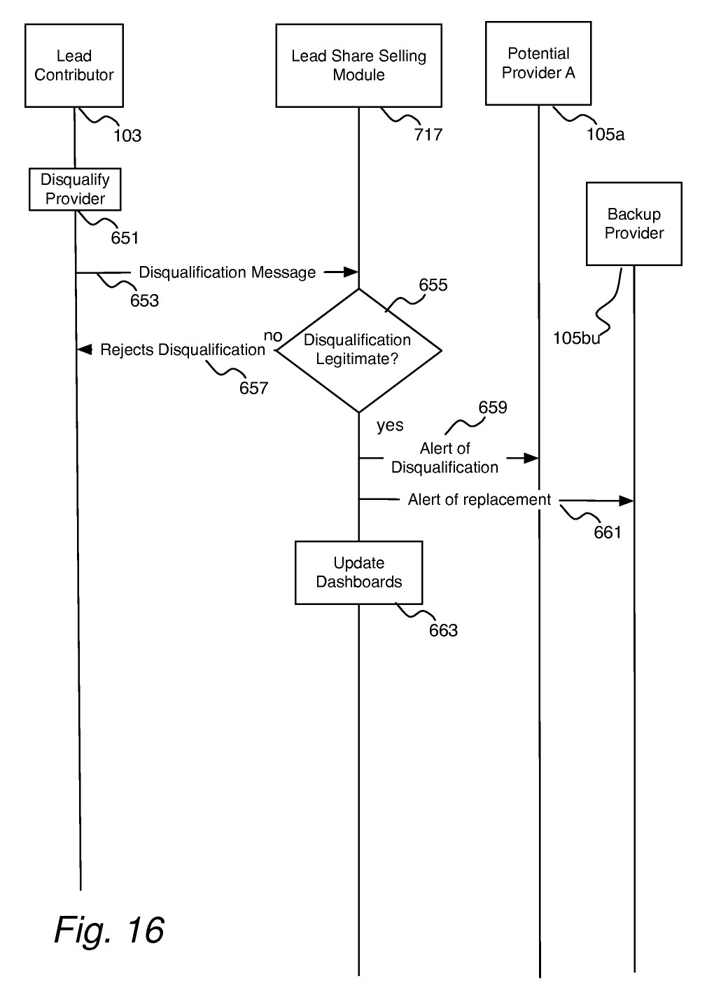

The lead contributor 103 may disqualify the potential provider 105 by sending a disqualifying message to the lead share selling module 717, step 569. Disqualification reasons might include the potential provider 105 is a current provider, the potential provider had a previous dispute with the lead contributor 103, or the lead contributor 103 is aware of factors that should have made the potential provider 105 ineligible, e.g., qualifications, geographic location, etc. FIG. 16 is a timing-sequence diagram illustrating the processing and message flow associated with a disqualification message. If the lead contributor 103 indicates a wish to disqualify the share purchase by a potential provider 105, step 651, and thereby causes a transmission of a disqualification message 653 to the lead share selling module 717, an administrator of the lead broker system 451 analyzes the reasons for disqualification, step 655, and either rejects the disqualification, including transmitting a message to that effect to the lead contributor 103, message 657, or disqualifies the potential provider who had purchased the share 105a. If the disqualification is legitimate, the lead share selling module 717 transmits an alert to the potential provider 105a who had purchased a share in the lead and who was disqualified, step 659, the potential provider 105a is refunded the money paid for the share from the escrow account for the third-party recipient 107. Further, the lead share selling module 717 transmits an alert to the backup potential provider 105bu who has purchased a backup share and who is awarded the replacement share, step 661. Finally, the lead share selling module 717 updates the dashboards of concerned users, step 663.

During the life of a lead, the purchase price for a share in a lead may change to reflect the demand for shares in the lead. The pricing module 471 provides the share price setting functionality. There can be a multitude of embodiments of this pricing module 471, including typical methods like flat pricing and seller auctions; however, these methods optimize only one but not both of the following goals: maximize the sale price of all shares sold, and also minimize each share and total share sell time. In the first embodiment, referred to herein as “Simulated Demand by Rate of Sale”, pricing of shares are dynamically changed based on the rate of share sales. An alternative embodiment, referred to herein as “Continuous Sealed Auction”, of pricing module 471 illustrated in FIG. 19 balances the two goals. The pricing module 471 is invoked when a lead is first created, for example, in conjunction with the lead abstraction phase, by setting an initial price which is adjusted during the course of selling lead shares in response to the rate at which shares are sold.

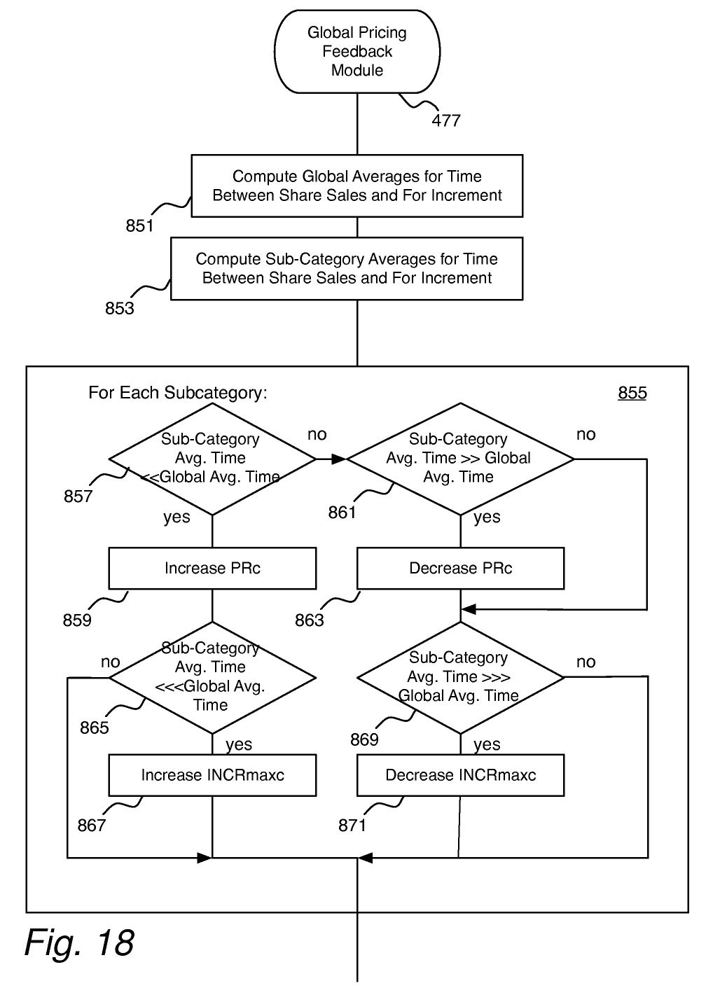

The pricing module 471, operating according to the “Simulated Demand by Rate of Sale” pricing approach, thus operates according to two workflows, the setting of an initial price and the resetting of share price in response to sales of shares in a lead, which is illustrated in the timing-sequence diagram FIG. 17. The sale of first shares in leads within a category may also be used to influence the price of the first share in future leads provided within that same category. This re-pricing of first shares within a lead category is illustrated in FIG. 18.

The workflows of FIG. 17 and examples that follow that illustrate share sales and share pricing utilize the following terminology:
EXP=expiry period of sale, i.e., the period during which shares in a lead may be purchased. This period is specified by the lead contributor 103 during the lead input phase.
PRₙ=Price of the n^{th} share, i.e., PR₁ is the price of the first share, PR₂ is the price of the second share, etc.
MIN=Minimum number of bids required. This is specified by the lead contributor 103 during the lead creation phase. In one embodiment, the MIN is set to a default of 2. If fewer than MIN shares have been sold, in one embodiment, the lead contributor 103 is provided the option to proceed with the lead shares sold or to extend the EXP value to allow for further lead share sales.
N=Number of shares offered.
MAX=Maximum number of shares that any one potential provider 105 may purchase at any one time.
DN_{c}=Default value for the value N by category c. The lead brokerage system 451 provides a default value for the number of shares offered for each category. In one embodiment, the default value for most sub-categories is 4. The default value may be reset as a function of the number of potential providers 105 that subscribe to any particular sub-category, e.g., DN_{c}=½ of the number of potential providers 105 that subscribe to sub-category c. The value DN_{c} for each category is managed by the category management module 703 in the lead category database table 713.
PR_{c}=the value for PR₁ for each subcategory. The value PR_{c} for each category is managed by the category management module 703 in the lead category database table 713. The initial values for PR_{c} may be set by an administrator of the lead brokerage system 451 based on estimates for the value of leads in particular sub-categories. The global pricing feedback module 477 (described herein below) resets the PR_{c} based on share sales in a particular category.
BK=number of backup shares offered. A backup share does not provide access to the lead unless one of the primary shares becomes disqualified. In a sense, a backup share is akin to purchasing an option to buy a share if an already-sold share is disqualified.
TIMₙ=the time elapsed between the sale of the n^{th} and the (n-1)^{th} shares, i.e., TIM₁=the time between the opening of sales of shares in a lead and the first sale of a share, TIM₂=the time between the sale of the 1^{st} share and 2^{nd} share.
INCR=the amount by which to increase the price of the next share if the time between share sales dictate a price increase.
DEM_{high}=is a threshold against which the time between two sequentially adjacent share sales can be compared to determine whether there is a high demand for shares.
DEM_{highc}=the threshold where the global pricing feedback module 477 adjusts the PR_{c} and INCR_{maxc} for each category c (see description below). In a preferred embodiment, DEM_{highc}=average time between share sales for sub-category c is 25% less than the global average time between share sales.

In a preferred embodiment certain of these values are given default values as follows:
EXP=a lead contributor 103 may not set an EXP value lower than 48 hours.
PR₁ for a lead is set to the PR_{c} for the corresponding category.
N=the larger of DN_{c} and (MIN+1).
MAX<= 1/2 N; provided that having a MAX value as large as ½ N still allows MIN to be satisfied with the remaining unsold shares (RE).
BK=2 and that backup shares are only offered for sale after all N shares in a lead have been sold.
PR_{BK1} & PR_{BK2}=½ PR₁; i.e., the price of the backup shares is set to one half of the price of the first share.

When the lead share selling module 717 is first invoked, e.g., as a transition in the workflow of FIG. 8 from the modules that create a lead, e.g., lead input module 701 through lead abstraction module 709, to the lead share selling module 717, the pricing module is invoked to set a price for the first share. The pricing module 471 retrieves the sub-category specific first share price (PR_{c}) from the category table 713, step 751. The pricing module 471 sets the price for the first share (PR₁) to sub-category specific first share price (PR_{c}) and the current price to PR₁. The current price is always the price to be charged for the next share sold. When a potential provider 105 signs in to the lead brokerage system 451, the dashboard of the potential provider 105 displays leads for which the potential provider 105 may purchase shares. The dashboard displays the current price for the share.

At some time later the share selling module 473 sells a share to a potential provider 105, step 755. The time of that sale is recorded as TIMₙ. The share selling module 473 transmits (or records in a database record) the time TIMₙ, message 757.

The price of the next share is determined from the perceived demand in shares in the lead. The price is never allowed to drop. Demand is correlated against how quickly shares sell. High demand is defined by the expired time between share sales, e.g., the time between the sale of share n and share n-1. A high demand may be defined by expired time between share sales being less than or equal to a defined threshold and low demand being that the expired time exceeds the same threshold. In one embodiment the Threshold is set to max((1/N*½ XP), 4 hours). In one embodiment, the demand threshold is adjusted based on sub-category or global averages (as described herein below).

Thus, the pricing module 471 compares the expired time (TIMn−TIMn−1) to the Threshold. The Threshold may be retrieved from the category table 713 or if no category-specific threshold has been set, a global threshold may be retrieved (not shown), step 759. The expired time between share sales is then compared to the threshold, step 761.

If demand is high, i.e., the threshold has been exceeded, the share price for the next share (PRₙ₊₁) is set to the current share price (PRₙ) plus an increment (INCR), step 765; otherwise the price is held the same as the previous share price, step 767. The increment (INCR) is also correlated to demand. A maximum increment is defined for each sub-category and maintained in the category table 713. In one embodiment, the INCR price is set as follows:

SELLTIME=TIMₙ−TIMₙ₋₁

TIMERATIO=SELLTIME/Threshold; determine a ratio between the sell time and the Threshold

INCRn=round((1−TIMERATIO)*INCR_{maxc},10); round by 10

In other words, the ratio between the sell time and the threshold is determined. The one's complement of that ratio times the maximum increment for the subcategory is used to determine the increment to be used to compute the next share price. Thus, a shorter time between share sales increases the increment and consequently the share price is increased more when shares are sold quickly.

As noted above, the dashboards always display the current price. The lead brokerage system 451 maintains knowledge of which is the next share to be sold. Thus, PRₙ₊₁ is the current price. However, in one embodiment this value assignment may be made explicitly, step 769.

As discussed hereinabove, the pricing module 471 sets the price of the first share PR₁ based on a first price set for the sub-category of the lead, steps 751 and 753. The price of subsequently sold shares are priced at a higher price if the demand for the lead appears to be high. The increment is determined from a sub-category-based valued referred to as the maximum increment for that sub-category (INCR_{maxc}). PR_{c} and INCR_{maxc} are stored in the category database table 713 and are dynamically adjusted using a global pricing feedback module 477. As a basic premise, the PR_{c} and INCR_{maxc} values are adjusted in response to demand within a given subcategory. The global pricing feedback 477 may be executed periodically to adjust these parameters, for example, once every night or after a particular number of transactions have taken place. Backup shares are priced according to a separate algorithm. Because backup shares have a lower value than real shares, backup shares would typically be priced lower than any real share, for example, at ½ the price of the first share sold.

FIG. 18 is a flowchart illustrating the operation of one embodiment of the global pricing feedback module 477 applicable for the Simulated Demand by Rate of Sale embodiment of pricing module 471. First the pricing module 471 calculates global averages for the average time between share sales for all share sales made during a specified period and the average price increment applied for these share sales, step 851. The global averages are for all leads regardless of subcategory.

Next the global pricing feedback module 477 calculates the averages for the average time between share sales for all share sales made within each sub-category during a specified period and the average price increment applied for these share sales, step 853.

For each sub-category the PR, and INCR_{maxc} values are adjusted by comparing the sub-category average time between share sales to the global average time between share sales, loop 855.

If the sub-category specific average time between share sales is less than a specified threshold (DEM_{highc}) of the global average time between share sales, step 857, that is an indication that there is a relatively high demand for leads in that lead sub-category. Accordingly, the PR_{c}, the starting price for share sales in that sub-category, is increased, step 859. The amount of the increase may be a system parameter.

Conversely, if the sub-category specific average time between share sales is beyond a specified threshold (DEM_{highc}) greater than the global average time between share sales, step 861, that is an indication that there is a relatively low demand for leads in that lead sub-category. Accordingly, the PR_{c}, the starting price for share sales in that sub-category, is decreased, step 863. The amount of the increase may be a system parameter.

If the sub-category specific average time between share sales is very much less, for example, more than two times the standard deviation quicker than the global average time between share sales, step 865, that is an indication that there is a relatively a very high demand for leads in that lead sub-category, then the amount of the increase of the prices from share sale-to-share sale is also adjusted by increasing the INCR_{maxc} value, step 867. The amount of the increase may be a system parameter.

If the sub-category specific average time between share sales is very much greater than, for example, more than two times the standard deviation slower than the global average time between share sales, step 869, that is an indication that there is a relatively a very low demand for leads in that lead sub-category, then the amount of the increase of the prices from share sale-to-share sale is also adjusted by decreasing the INCR_{maxc} value, step 871. The amount of the decrease may be a system parameter.

The second embodiment of the pricing module 471, to be referred to as “Continuous Sealed Auction,” is an improvement of standard seller auctions, essentially creating a continuum of multiple sealed bid auctions to capture the benefits of auctions and to maximize lead selling price without the problems of a long auction period. The Continuous Sealed Auction embodiment divides the share sale process into a number of blocks of time in which shares in the lead are sold by means of a sealed auction within each block of time.

The Continuous Sealed Auction embodiment of pricing module 471 provides two workflows, the auction process, illustrated by the flowchart of FIG. 19 and an alternative workflow for the global pricing feedback module 477. The final winning auction price of leads within a category may also be used to influence the minimum or reserve price in future leads provided within that same category. This re-pricing of the reserve price within a lead category is illustrated in FIG. 20.

The workflow of FIG. 19 and examples that follow illustrate share sales and share pricing according to the continuous auction embodiment of the pricing module 471 and utilizes the following terminology:
BLOCK=preset time for each mini-auction, for example, 48 hours. This period is set by the value of BLOCK_{c} (see below).
EXP=expiry period of sale, i.e., the period during which shares in a lead may be purchased. This period is specified by the lead contributor 103 during the lead input phase and is a multiple of BLOCK.
OFFERₙ=Dollar amount offered by n^{th} auction bidder, a potential provider 105, in the overall auction, i.e., OFFER₁ is the price that the 1^{st} bidder in the auction is willing to pay for a share, OFFER₂ is the price that the 2^{nd} bidder in the auction is willing to pay for a share, etc.
WONₙ=Dollar amount (price) accepted as winner of the n^{th} share, i.e., WON₁ is the sale price of share 1, WON₂ is the sale price of share 2, etc.
RESERVE=minimum price that the Share Selling Module 473 accepts as for an OFFER by an auction bidder. This price is set by the value of RESERVE_{c} (see below).
MIN=Minimum number of bids required. This is specified by the lead contributor 103 during the lead creation phase.
N=Number of shares offered.
DN_{c}=Default value for the value N by category c. The lead brokerage system 451 provides a default value for the number of shares offered for each category. In one embodiment, the default value for most sub-categories is 4. The default value may be reset as a function of the number of potential providers 105 that subscribe to any particular sub-category, e.g., DN_{c}=½ of the number of potential providers 105 that subscribe to sub-category c. The value DN_{c} for each category is managed by the category management module 703 in the lead category database table 713.
BLOCK_{c}=default value for the value BLOCK by category c. The value BLOCK_{c} for each category is managed by the category management module 703 in the lead category database table 713. The initial values for BLOCK_{c} may be set by an administrator of the lead brokerage system 451 based on estimates for the value of leads in particular sub-categories. The global pricing feedback module 477 when operating according to the process illustrated in the flow-chart of FIG. 20 (described herein below) resets the BLOCK_{c} based on share sales in a particular category.
RESERVE_{c}=the reserve and minimum price for all offers in the auction for each subcategory. The value RESERVE_{c} for each category is managed by the category management module 703 in the lead category database table 713. The initial values for RESERVE_{c} may be set by an administrator of the lead brokerage system 451 based on estimates for the value of leads in particular sub-categories. The global pricing feedback module 477 when operating according to the process illustrated in FIG. 20 (described herein below) resets the RESERVE_{c} based on share sales in a particular category.
DEM_{highc}=the threshold where the global pricing feedback module 477 adjusts the RESERVE_{c} for each category c (see description below). In a preferred embodiment, DEM_{highc}=average gap of price (difference between RESERVE and WON for all share sales in subcategory)>4× RESERVE.

In a preferred embodiment certain of these values are given default values as follows:
EXP=a lead contributor 103 may not set an EXP value lower than 1 BLOCK hours, and all EXP values are a multiple of BLOCK.
RESERVE for a lead is set to the RESERVE_{c} for the corresponding category.
BLOCK for a lead is set to the BLOCK_{c} for the corresponding category.
N=the larger of DN_{c} and (MIN+1).

When the lead share selling module 717 is first invoked, e.g., as a transition in the workflow of FIG. 8 from the modules that create a lead, e.g., lead input module 701 through lead abstraction module 709, to the lead share selling module 717, the pricing module 471 is invoked to setup a sealed auction for BLOCK 1 (first BLOCK). The pricing module 471 receives an abstracted lead from the lead abstraction module 709, step 971. The pricing module 471 retrieves the sub-category specific reserve share price (RESERVE_{c}) and the sub-category specific BLOCK period (BLOCK_{c}) from the category table 713, step 973, and these values are set as initial values for loop variables BLOCK and RESERVE, step 975. Furthermore, the number of shares to be sold is determined as the larger of two values: DN_{c}: the minimum number of shares to be sold in a given category c, or MIN+1: the minimum number of bids sought by the lead contributor 103 plus 1, step 975.

Successive auctions are held until all shares have been sold, loop 977.

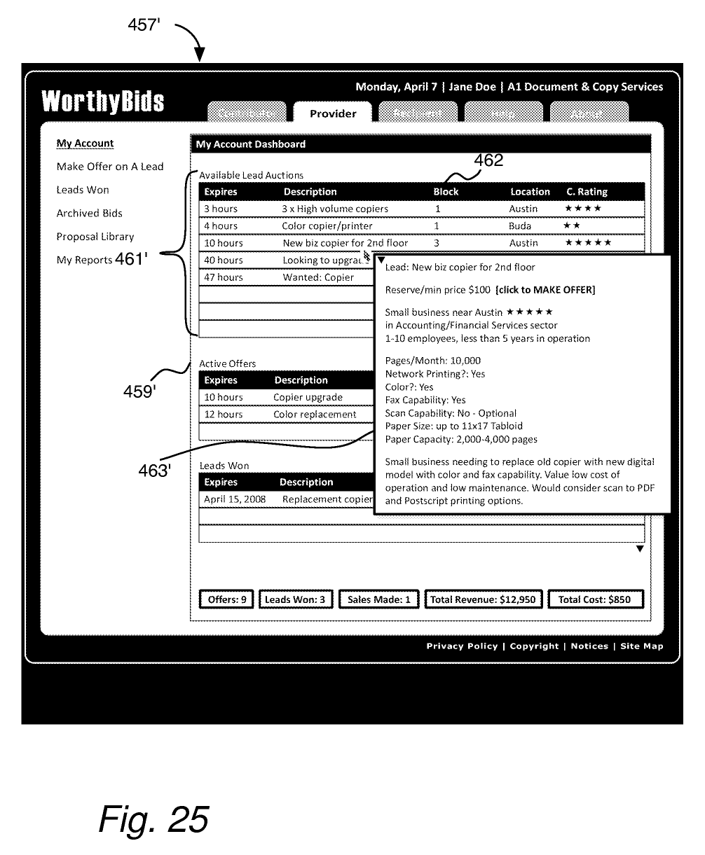

When a potential provider 105 signs in to the lead brokerage system 451, the dashboard of the potential provider 105 displays auctions of leads for which the potential provider 105 may make offers for shares, step 979. The dashboard only displays that the auction is open (still has remaining shares), how much time remaining in the current BLOCK, and which BLOCK the auction is in. The dashboard does not show the highest offer for the auction, how many offers have been received for the auction, how many remaining shares are available for the auction. FIG. 25 is a screenshot illustrating the provider portal 457′ when the continuous sealed auction pricing method is employed. The dashboard 459′ lists available lead share auctions 461′ available to the provider 105 to bid on. For each auction the current BLOCK is listed 462. Hovering the cursor over a particular auction brings up a detail window 463′ providing additional information about that auction and providing the provider 105 and opportunity to bid in the auction for share leads.

At the end of the current BLOCK, i.e., when the time allotted for auctioning out shares in a current BLOCK, the lead brokerage system 451 accepts the highest offers received until all the remaining shares have been sold, step 981.

If all the shares have not been sold, decision 983, a new auction block is started, step 985.

When all the shares have been sold or when all auction blocks have been executed the auctions for shares end, step 987.

The sealed nature of the auction eliminates the waiting nature of auctions, i.e., the common phenomena observed in online auctions in which bidders wait until the auction has nearly expired to make their offers so as to not be outbid. Potential providers 105 may only make one offer per auction; they can at a later time, before the expiration of the BLOCK, increase their offer price (OFFER) but can never decrease the offer price.

FIG. 20 is a flowchart illustrating the operation of an alternative embodiment of the global pricing feedback module 477 applicable for the Continuous Sealed Auction embodiment of pricing module 471. The pricing module 471 starts the pricing feedback process by computing global averages for the difference between the RESERVE and WON price for each share sold, step 881. Next averages for the difference between the RESERVE and WON prices for all share sales in each sub-category is computed, sep 883.

For each sub-category, loop 885, new values for the reserve price for the subcategory, RESERVE_{c} and the length of time for the next auction block, BLOCK_{c}, are computed. To do so, the sub-category average difference from step 883 is compared to the global average differences from step 881, steps 887 and 889. If the sub-category average is beyond a specified threshold (DEM_{highc}) greater than the global average, the RESERVE_{c} is decreased and the BLOCK_{c} is increased, step 891. Conversely, if the sub-category average difference is beyond a specified threshold (DEM_{highc}) greater than the global average difference, the RESERVE_{c} is increased and the BLOCK_{c} is decreased, step 893. The increments and decrements for RESERVE_{c} and BLOCK_{c} may be set in various ways, e.g., to also be a function of the difference between share sale-price average for a category versus a global share sale-price average or, simply, fixed on a per-category basis, e.g., $10 for the increment/decrement for RESERVE_{c} and 2 hours, for BLOCK_{c}.

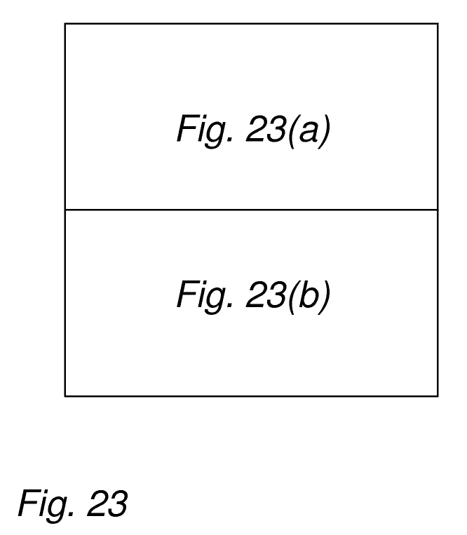

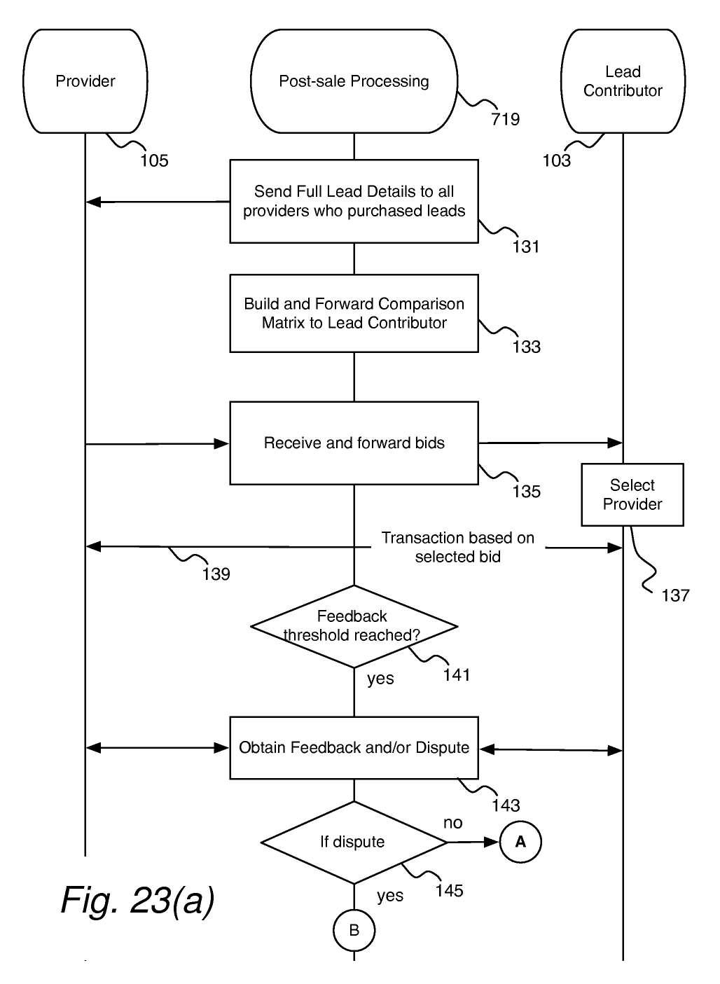

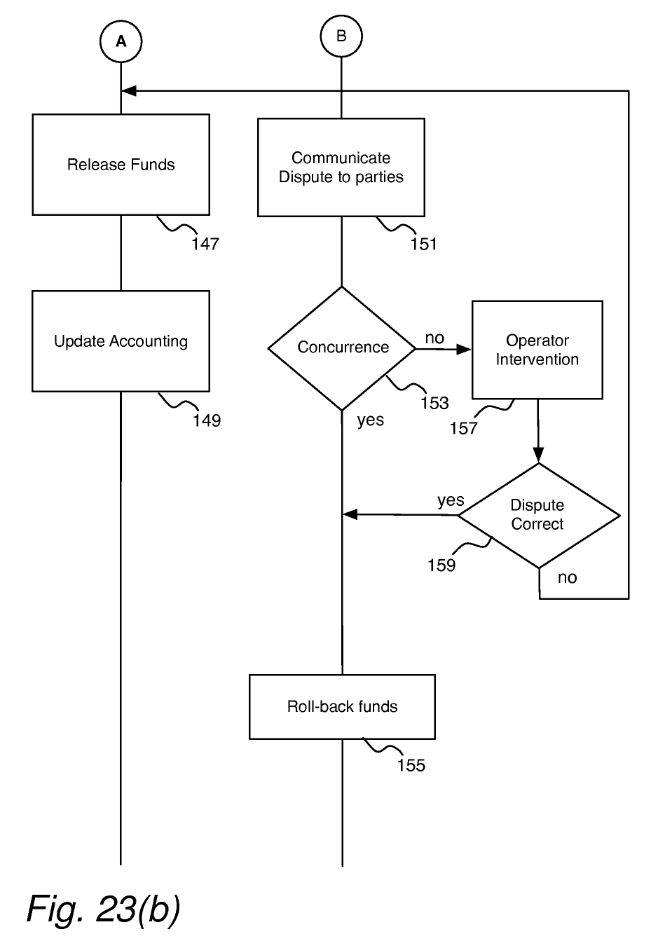

In the work flow of FIG. 8, the lead share selling module 717 is followed by the post-sale processing module 719. FIG. 23 is a timing-sequence diagram illustrating the processing of the post-sale processing module 719 and related message flow.

When all shares have been sold, the post-sale processing module 719 transmits the full-lead details to the providers who successfully purchased shares in the lead, step 131.

The post-sale processing module 719 also provides the lead contributor 103 with a comparison matrix illustrating information obtained from providers 105 who purchased shares in the lead and other known information about the providers. Accordingly, information concerning the bid provided by the potential provider 105 who has purchased a lead is obtained, step 133. In FIG. 24, the comparison matrix is illustrated in the pop up window 283 providing details concerning the competed lead 281. The comparison matrix may contain information obtained from an existing vendor by the existing vendor checking module 705.

Returning to FIG. 23, having received lead details, the provider 105 may forward bids to the lead contributor 103 via the lead brokerage system 451, step 135. Having received bids from potential providers 105 who purchased shares in the lead, the lead contributor 103 may select a provider with whom to do business, step 137. In one embodiment, the actual transaction between the provider 105 that the lead contributor 103 selects and the lead contributor 103 takes place outside of the lead brokerage system 451, step 139.

After some threshold time has elapsed after the closing of the sale of shares in a lead, step 141, the post-sale processing module 719 interacts with the lead contributor 103 and the potential providers 105 who purchased shares in the lead to obtain feedback in regard to the sale and purchase of the lead, step 143. The feedback may consist of transmitting a questionnaire to the lead contributor 103 to rate the overall satisfaction of the sale of shares in the lead, rate the providers who purchased shares in the lead, specify the winner of the bid contest between the providers who purchased shares in the lead, and reasons for rejecting proposals from the providers who provided bids. The potential provider 105 who was awarded the sale of the desired goods or services is provided a similar survey, e.g., rating the lead contributor 103.

The providers 105 and the lead contributor 103 may also communicate disputes in regard to the sale of share of leads, step 143. If there is no dispute, step 145, the post-sale processing module 719 proceeds with distribution of the funds placed in escrow, step 147, and accounting records are updated, step 149. If, on the other hand, there is a dispute, step 145, the dispute is communicated to the parties involved, step 151, and if there is a concurrence among the parties in regard to the dispute, funds held in escrow are rolled back, step 155. If the dispute is contested, step 153, an operator of the lead brokerage system 451 with administrative privileges may have to intervene to determine the whether the dispute should be resolved in favor of the disputing party or not, step 157. If the operator determines that the dispute is correct, the operator may rule to roll back the funds held in escrow, step 155, or may cause the funds to be released, step 147, if the dispute is not valid.

Returning now to FIG. 5, the lead brokerage system 451 contains a lead monitoring module 505. The lead monitoring module 505 contains instructions to retrieve information from the leads table 711 to produce the appropriate dashboards as described hereinabove.

The lead broker system 451 further contains a fraud detection module 507. The fraud detection module contains instructions to implement rules to detect fraud, abuse, or inappropriate use of the lead brokerage system 451. An example rule is that a provider 105 may not contribute leads in a category to which the provider is registered with the lead brokerage system 451 for receiving lead alerts.

The lead brokerage system 451 further contains an accounting module 509 that consists of instructions to update and track accounting information relating to the sale of shares of leads.

Simulated Demand by Rate of Sale Pricing Method: Examples

The following examples illustrate the operation of the lead brokerage system 451 with some hypothetical scenarios. Some values, e.g., PR_{c} and DN_{c}, are presumed. The value DEM_{high} below designates the threshold used to indicate whether there is high or low demand.

Scenario #1:
A lead contributor 103 enters lead for a digital copier/fax/printer/scanner into “small copier” subcategory (lead input module 701). The lead is abstracted (lead abstraction module 709). Eligible providers 105 are matched and alerted (lead matching and alerting module 715).
The lead contributor 103 specified:
   MIN=3; at least three bids are desired
   EXP=7 days (168 hrs); lead share sales end after 7 days
System determines parameters of lead:
   N=4; based on DN_{c}=4 and MIN=3, and N=DN, or (MIN+1), whichever is greater
   PR₁=$100; based on P=$100
   MAX=2; based on ½N
   BK=2, PR_{bk1} and PR_{bk2}=$50 (½ PR₁)
   DEM_{high}=4 hrs; based on (1/N*½ XP) or 4 hrs, whichever is lower
   INCR_{maxc}=$50
   INCRₙ=round((1−(TIMₙ₋₁/DEM_{high}))*INCR_{maxc},10); rounded up to the next $10
Sale 1: This is a relatively quick sale, therefore the next share price will be higher.
   P1=PR₁=$100
   Number of shares=1
   Sold after 1 hr
   PR₂ increases because 1 hr<=DEM_{high}(4 hr)
   INCR₂=round((1−(TIM₁/DEM_{high})*INCR_{maxc},10)=round((1¼)*50,10)=$40
   PR₂=P₁+INCR₂=$100+$40=$140
Sale 2: Again, a quick sale causing an increase in share price.
   P2=PR₂=$140
   Number of shares=1
   Sold 3 hrs after sale of 1^{st} share
   PR₃ increases since 3 hr<=DEM_{high}(4 hr)
   INCR₃=round((1−(TIM₂/DEM_{high}))*INCR_{maxc},10)=round((1¾)*50,10)=$10
   PR₃=P₂+INCR₃=$140+$10=$150
Sale 3: This sale is slower; it exceeds the DEM_{high} threshold, therefore there is no price increase for the next share.
   P3=PR₃=$150
   Number of shares=1
   Sold 24 hrs after sale of 2^{nd} share
   PR₄ does NOT increase because 24 hr>DEM_{high}(4 hr)
   INCR₄=0
   PR₄=PR₃=$150
Sale 4:
   P4=PR₄=$150
   Number of shares=1
   Sold 20 hrs after sales of 3^{rd} share
   No P₅ since all shares sold
   Total time so far: 48 hrs out of 168 hrs available
   Lead sale complete enough for the lead contributor 103 to evaluate proposals from the potential providers 105 who purchased shares; lead contributor 103 and the potential providers 105 who purchased shares are notified, optionally Backup shares are offered.
Backup Sale 1:
   PR_{bk1}=$50; based on PR_{bk1}=½ PR₁
   Sold 10 hrs after sale of 4^{th} share
No disputes, no disqualification of Providers. Sale of lead is finalized.
Contributor CLOSES lead sale at 58 hrs after lead insertion.
Total net fees collected: $590. Funds held in escrow account pending.
Lead moves into next module (post-sale processing module 719) and funds are released if there is no reason to disqualify any lead share sales.

Scenario #2:
A lead contributor 103 enters a lead for annual landscaping contract worth $2400/year ($200/mth) into “landscaping—commercial property” subcategory (lead input module 701). The lead is abstracted (lead abstraction module 709). Eligible providers 105 are matched and alerted (lead monitoring module 505).
The lead contributor 103 specified:
   MIN=3
   EXP=4 days (96 hrs)
System determines parameters of lead:
   N=5; based on DN_{c}=5 and MIN=3, and N=DN_{c} or (MIN+1), whichever is greater
   PR₁=$100; based on PR_{C}=$100
   MAX=2; based on ½N
   BK=2, PR_{bk1} and PR_{bk2}=$50 (½ PR₁)
   DEM_{high}=4 hrs; based on (1/N*½ EXP) or 4 hrs, whichever is lower
   INCR_{maxc}=$50
   INCRₙ=round((1−(TIMₙ₋₁/DEM_{high}))*INCR_{maxc},10); rounded up to the next $10
Sale 1: The first sale is slow and indicates low demand. Accordingly the share price is not increased.
   P1=PR₁=$100
   Number of shares=2
   Sold after 5 hr
   PR₂ does NOT increases because 5 hr>DEM_{high}(4 hr)
   INCR₂=0
   PR₂=P₁=$100
Sale 2: This is a quicker sale. Therefore, the share price is increased.
   P2=PR₂=$100
   Number of shares=1
   Sold 3 hrs after sale of 1^{st} share
   PR₃ increases since 3 hr<=DEM_{high}(4 hr)
   INCR₃=round((1−(TIM₂/DEM_{high}))*INCR_{maxc},10)=round((1¾)*50,10)=$10
   PR₃=P₂+INCR₃=$100+$10=$110
Sale 3:
   P3=PR₃=$110
   Number of shares=1
   Sold 2 hrs after sale of 3^{rd} share (2^{nd} sale)
   PR₄ increases since 2 hr<=DEM_{high}(4 hr)
   INCR₄=round((1−(TIM₃/DEM_{high}))*INCR_{maxc},10)=round((1 2/4)*50,10)=$30
   PR₄=P₃+INCR₄=$110+$30=$140
Sale 4:
   P4=PR₄=$140
   A potential provider 105 wanted to buy 2 shares but RE=1, so number of shares sold=1
   Sold 80 hrs after sales of 4^{th} share (3^{rd} sale)
   No P₅ since all shares sold
   Total time so far: 90 hrs out of 96 hrs available
   Lead sale complete enough for lead contributor 103 to evaluate proposals from the providers 105 who purchased the lead; lead contributor 103 and potential provider 105 who purchased the leads are notified, optionally Backup shares are offered.
No backup shares are sold when 96 hr EXP time elapses to automatically CLOSE lead sale.
The lead contributor 103 disputes buyer 1 as being existing vendor to the lead contributor 103. Buyer 1 gets refund for both shares purchased. Number of total bids drops to 3. Still the sale satisfies the minimum required number of bids (MIN).
Total net fees collected: $350. Funds held in escrow account pending.
Lead moves into next module (post-sale processing module 719) and funds are released if there is no reason to disqualify any lead share sales.

### EXAMPLES

### Continuous Sealed Auction Pricing Method

The following examples illustrate the operation of the lead brokerage system 451 with some hypothetical scenarios using the Continuous Sealed Auction Pricing method. Some values, e.g., BLOCK_{c}, RESERVE_{c} and DN_{c} are presumed.

Scenario #3
A lead contributor 103 enters lead for an I.T. (information technology) service into the “contract I.T.” subcategory (lead input module 701). The lead is abstracted (lead abstraction module 709). Eligible providers 105 are matched and alerted (lead matching and alerting module 715).
The lead contributor 103 specified:
   MIN=3; at least 3 bids are desired
   EXP=8 days (4 BLOCKS); lead share sales end after 8 days, or 4 BLOCKS as each BLOCK=48 hrs
System determines parameters of lead:
   N=4; based on DN_{c}=4 and MIN=3, and N=DN_{c} or (MIN+1), whichever is greater
   RESERVE=$100; based on RESERVE_{c}=$100
BLOCK 1:
   The following offers are received:
      OFFER1=$110
      OFFER2=$120
      OFFER3=$150
      OFFER4=$100
      OFFER5=$110
      BIDDER3 later changes OFFER3 to $180
   At end of 48 hrs (1st Block). NB>=N. Auction ends. Highest N bidders each get a share:
      BIDDER3 wins a share with $180
      BIDDER2 wins a share with $120
      BIDDER1 wins a share with $110
      BIDDER5 wins a share with $110
      BIDDER4 looses.
No disputes, no disqualification of Providers. Sale of lead is finalized.
Contributor CLOSES lead sale at 48 hrs after lead insertion (1 BLOCK).
Total net fees collected: $520. Funds held in escrow account pending.
Lead moves into next module (post-sale processing module 719) and funds are released if there is no reason to disqualify any more lead share sales.

Scenario #4
A lead contributor 103 enters lead for a wedding planner into the “personal services” subcategory (lead input module 701). The lead is abstracted (lead abstraction module 709). Eligible providers 105 are matched and alerted (lead matching and alerting module 715).
The lead contributor 103 specified:
   MIN=4; at least 4 bids are desired
   EXP=8 days (4 BLOCKS); lead share sales end after 8 days, or 4 BLOCKS as each BLOCK=48 hrs
System determines parameters of lead:
   N=5; based on DN_{c}=4 and MIN=4, and N=DN_{c} or (MIN+1), whichever is greater
   RESERVE=$100; based on RESERVE_{c}=$100
BLOCK 1:
   Offers:
      OFFER1=$110
      OFFER2=$120
   At end of 48 hrs (1st Block). NB<N. Auction continues to BLOCK2. Highest bidders in BLOCK 1 each get a share:
      BIDDER1 wins a share with $110
      BIDDER2 wins a share with $120
BLOCK 2:
   Offers:
      OFFER3=$100
      OFFER4=$150
   At end of 96 hrs (BLOCK 2). NB<N. Auction continues to BLOCK 3. Highest bidders in BLOCK 2 each get a share:
      BIDDER3 wins a share with $100
      BIDDER4 wins a share with $150
BLOCK 3:
   Offers:
      OFFER5=$170
      OFFER6=$120
      OFFER7=$170
   At end of 144 hrs (BLOCK 3). NB>=N. Auction ends. Highest bidders in BLOCK 3 each get a share (ties, earlier bidder wins):
      BIDDER5 wins a share with $170
      BIDDER6 loses (low bid).
      BIDDER7 loses (tied but later bid).
Auction summary, winners:
   BIDDER1 wins a share with $110
   BIDDER2 wins a share with $120
   BIDDER3 wins a share with $100
   BIDDER4 wins a share with $150
   BIDDER5 wins a share with $170
The lead contributor 103 disputes BIDDER1 as being existing vendor to the lead contributor 103. BIDDER1 gets refund. Number of total bids drops to 4. Still the sale satisfies the minimum required number of bids (MIN).
Contributor CLOSES lead sale at 144 hrs after lead insertion (3 BLOCKs).
Total net fees collected: $540. Funds held in escrow account pending.
Lead moves into next module (post-sale processing module 719) and funds are released if there is no reason to disqualify any more lead share sales.

Conclusion

From the foregoing it will be apparent that a lead brokerage system as described herein provides a new powerful and flexible approach to monetize the value of leads by selling shares in abstracted leads to potential providers of desired goods and services while using the proceeds of such sales to provide funds for third-party recipients, for example, non-profit organizations.

Although specific embodiments of the invention have been described and illustrated, the invention is not to be limited to the specific forms or arrangements of parts so described and illustrated. The invention is limited only by the claims.

We claim:

1. A method for operating a computer system wherein a lead broker provides a first party an opportunity to contribute leads for sale to a plurality of second parties, such that a sale of a lead contributed by the first party to at least one second party, operates to confer a benefit to a third party recipient from the sale of leads, comprising:
operating the computer system to electronically:
receive a lead entry from the lead contributor via the lead entry user interface over a computer network, the lead entry having a lead description describing a desired good or service;
transmit an alert of the lead to potential providers inviting the potential providers to buy a share in the lead over a computer network;
receive a lead purchase request from the requesting potential provider including a payment for the lead over a computer network; and
process the lead purchase request on a computer processor by including crediting an account of a third party recipient with a portion of the payment for the lead purchase wherein the third party is an entity other than the lead broker.

2. The method of claim 1 further comprising:
operating the computer system to electronically:
transmit a lead entry user interface over a computer network from the computer system to a lead contributor operating a receiving device thereby providing the lead contributor a mechanism to describe a desired good or service.

3. The method of claim 1 further comprising:
operating the computer system to electronically:
receive a designation of the third party recipient over a computer network from the lead contributor and storing the third party recipient designation with the lead entry on a computer readable storage medium.

4. The method of claim 1 further comprising:
operating the computer system to electronically:
abstract the lead on a processor prior to transmitting the lead to potential providers by operating the processor to remove information potentially identifying the lead contributor.

5. The method of claim 4 wherein the abstracting step comprises:
operating the computer system to electronically:
transform the lead entry on a processor into an abstracted lead entry including lead contributor size, and desired good and service features.

6. The method of claim 4 wherein the abstracting step further comprises operating the computer system to electronically perform a key word search on a processor, the key word search being performed on input fields of the lead entry to detect whether the lead contributor has entered identity-revealing information.

7. The method of claim 1 comprising:
operating the computer system to electronically:
operate a processor to price the lead according to a function of perceived demand for the lead.

8. The method of claim 7 wherein the pricing step comprises:
operating the computer system to electronically:
operate a processor to determine perceived demand as a function of how quickly a lead is sold.

9. The method of claim 8 wherein the pricing step comprises:
operating the computer system to electronically to operate a processor to:
designate a specified number of shares in a lead available for purchase where each share is available for purchase by an identified suitable provider;
set an initial price for a share purchase;
when a share is sold, if the share is sold quickly, to set the price for the next share equal to price of the sold share plus an increment, otherwise, to set the price for the next share equal to the price of the sold share.

10. The method of claim 9 comprising:
operating the computer system to electronically to operate a processor to:
set the initial price as a function of demand history within the lead category.

11. The method of claim 10 further comprising:
operating the computer system to electronically operate a processor to:
increase the initial price for a category when the time to the sale of shares is more frequent than a first specified threshold; and
decrease the initial price for a category when the time to the sale of shares is less frequent than a second specified threshold.

12. The method of claim 11 further comprising:
operating the computer system to electronically operate a processor to:
set the amount to increase or decrease the initial price for a category as a function of the length of time between sales of shares.

13. The method of claim 1 comprising:
operating the computer system to electronically to operate a processor to:
offer lead shares in an auction having r remaining shares for sale and an expiration time and in which the time between the opening of the auction and the expiration time is divided into a plurality of blocks and wherein at the conclusion of each block, having received m bids for lead shares within the block, n lead shares are sold to the highest n bidders within each block, wherein n is the lower of r and m; and if there are still some r shares and available blocks, the sale continues to an auction in the next block.

14. The method of claim 13 further comprising operating the computer system to electronically operate a processor to set a reserve price for each block and adjusting the reserve price on a per sub-category basis as a function of comparing average price for share sales in a sub-category to the average price for share sales globally.

15. The method of claim 2 wherein the lead entry user interface is a Web page transmitted over the Internet.

16. The method of claim 1 wherein crediting the recipient's account with a portion of the payment comprises placing the portion of the payment in an escrow account.

17. The method of claim 16 further comprising:
for each purchase of a lead, operating the computer system to electronically operate a processor to determine whether the purchase was a qualified purchase, and for each qualified purchase, transmitting the funds for that purchase held in escrow to the recipient.

18. The method of claim 17 wherein determination of a qualified purchase comprises obtaining feedback over a computer network from the lead contributor to operate a processor to ascertain that the lead purchase has no associated disputes or anomalies and to transmit the funds over a computer network to the third party recipient if there are no disputes or anomalies.

19. The method of claim 1 further comprising:
operating the computer system to electronically to operate a processor to:
operate a processor to classify the lead by lead category and comparing the lead category to corresponding categories of service providers in a provider database to determine suitable providers who may provide the good or service described in the lead and where transmitting the lead to potential providers is limited to distributing the lead to such suitable providers.

20. The method of claim 1 wherein the third party recipient designation designates the lead contributor as the third party recipient.

21. The method of claim 1 further comprising:
storing information concerning leads and purchases of shares on a storage medium;
updating the stored information concerning leads and purchases of shares on milestone events in the life of a lead;
retrieving the stored information;
transmitting the stored information on a user interface page over a computer network to a computer operated by a user whereby the updated stored information is displayed on the user interface device of a computer operated by the user.

22. A computer system for managing the sale of lead information to confer a benefit to a third party recipient from the sale of lead information, comprising:
a computer processor for processing data;
a storage device connected to the computer processor and on which the computer processor may store data and from which the computer processor may retrieve data;
a network interface for communicating data to other computer systems connected to a network;
the storage device having stored thereon instructions to cause the computer processor to:
receive a lead entry from the lead contributor entered via the lead entry user interface, the lead entry having a lead description describing a desired good or service;
transmit an alert of the lead to potential providers inviting the potential providers to buy a share in the lead;
receive a lead purchase request from the requesting potential provider including a payment for the lead; and
process the lead purchase request including crediting an account of the recipient with a portion of the payment.

23. The computer system of claim 22 wherein the instructions further include instructions to cause the computer processor to:
transmit a lead entry user interface from the computer system to a lead contributor operating a receiving device thereby providing the lead contributor a mechanism to describe a desired good or service.

24. The computer system of claim 22 wherein the instructions further include instructions to cause the computer processor to:
receive a designation of the third party recipient from the lead contributor and storing the third party recipient designation with the lead entry.

25. The computer system of claim 22 wherein the instructions further include instructions to cause the computer processor to:
abstract the lead prior to transmitting the lead to potential providers by removing information potentially identifying the lead contributor.

26. The computer system of claim 25 wherein the instructions to cause the processor to abstract the lead further comprises instructions to:
transform the lead entry into an abstracted lead entry including lead contributor size, and desired good and service features.

27. The computer system of claim 25 wherein the instructions to cause the processor to abstract the lead further comprises instructions:
to perform a key word search on input fields of the lead entry to detect whether the lead contributor has entered identity-revealing information.

28. The computer system of claim 22 wherein the instructions further include instructions to cause the computer processor to:
price the lead according to a function of perceived demand for the lead.

29. The computer system of claim 28 wherein the instruction to price the lead further includes instructions to:
determine perceived demand as a function of how quickly a lead is sold.

30. The computer system of claim 29 wherein the instruction to price the lead further includes instructions to:
designate a specified number of shares in a lead available for purchase where each share is available for purchase by an identified suitable provider;
set an initial price for a share purchase;
when a share is sold, if the share is sold quickly, setting the price for the next share equal to price of the sold share plus an increment, otherwise, setting the price for the next share equal to the price of the sold share.

31. The computer system of claim 30 wherein the instructions further include instructions to cause the computer processor to:
set the initial price as a function of demand history within the lead category.

32. The computer system of claim 22 wherein the instructions further include instructions to cause the computer processor to:
increase the initial price for a category when the time to the sale of shares is more frequent than a first specified threshold; and
decrease the initial price for a category when the time to the sale of shares is less frequent than a second specified threshold.

33. The computer system of claim 32 wherein the instructions further include instructions to cause the computer processor to:
set the amount to increase or decrease the initial price for a category as a function of the length of time between sales of shares.

34. The computer system of claim 22 wherein the instructions further include instructions to cause the computer processor to:
offer lead shares in an auction having r remaining shares for sale and an expiration time and in which the time between the opening of the auction and the expiration time is divided into a plurality of blocks and wherein at the conclusion of each block, having received m bids for lead shares within the block, n lead shares are sold to the highest n bidders within each block, wherein n is the lower of r and m; and if there are still some r shares and available blocks, the sale continues to an auction in the next block.

35. The computer system of claim 34 wherein the instructions further include instructions to cause the computer processor to set a reserve price for each block and adjusting the reserve price on a per sub-category basis as a function of comparing average price for share sales in a sub-category to the average price for share sales globally.

36. The computer system of claim 23 wherein the lead entry user interface is a Web page transmitted over the Internet.

37. The computer system of claim 22 wherein crediting the recipient's account with a portion of the payment comprises placing the portion of the payment in an escrow account.

38. The computer system of claim 37 wherein the instructions further include instructions to cause the computer processor:
for each purchase of a lead, to determine whether the purchase was a qualified purchase, and for each qualified purchase, transmitting the funds for that purchase held in escrow to the recipient.

39. The computer system of claim 38 wherein the instructions to determine qualified purchases comprises obtaining feedback from the lead contributor to ascertain that the lead purchase has no associated disputes or anomalies, and transmitting the funds to the third party recipient if there are no disputes or anomalies.

40. The computer system of claim 22 wherein the instructions further include instructions to cause the computer processor to:
classify the lead by lead category and comparing the lead category to corresponding categories of service providers in a provider database to determine suitable providers who may provide the good or service described in the lead and where transmitting the lead to potential providers is limited to distributing the lead to such suitable providers.

41. The computer system of claim 22 wherein the third party recipient designation designates the lead contributor as the third party recipient.

42. The computer system of claim 22 wherein the instructions further include instructions to cause the computer processor to:
store information concerning leads and purchases of shares on a storage medium;
update the stored information concerning leads and purchases of shares on milestone events in the life of a lead;
retrieve the stored information;
transmit the stored information on a user interface page to a computer operated by a user whereby the updated stored information is displayed on the user interface device of a computer operated by the user.

43. A method of using a computer to confer a benefit to a third party recipient from the sale of a lead, comprising:
receiving, using a computer, a lead from a lead contributor describing a desired product or service and a recipient;
transmitting the lead over a network to at least one potential provider;
receiving a lead purchase request from at least one potential provider including a payment for the lead; and
conferring a benefit to the recipient equal to a portion of the payment for the lead.

44. A server computer operable to monetize the value of leads by providing a mechanism by which leads are sold and conferring a benefit from such sales to third party recipients, comprising:
a processor connected to a storage system and having a communications interface by which the processor communicates over a computer network;
the storage system comprising instructions to cause the server to receive and transmit messages to client computers over the computer network, the instructions comprising:
a lead entry module for receiving leads from a lead contributor client computer and generating a lead abstraction;
a lead alerting module for transmitting the lead abstraction to at least one potential provider client computer;
a lead sales module for receiving a lead share purchase request from at least one potential provider client computer; and
a post sale processing module for distributing a portion of the proceeds from the sale of the lead share to a designated third party recipient.

45. The server computer of claim 44 wherein the storage system further comprises:
a database having entries describing users as lead contributors, lead providers and designated third party recipients, entries for categorizing leads, entries for leads created by users, and entries for managing lead purchases.

46. The server computer of claim 44 wherein the instructions further comprises:
a lead pricing module for pricing lead shares as a function of elapsed time between lead share sales.

47. The server computer of claim 46 wherein the instructions further comprises:
a pricing feedback module for setting the price for first shares sold as a function of lead category, sales history within the lead category, and share sales outside of the lead category, wherein the function compares average elapsed time to sale within the lead category to average elapsed time to sale outside of the lead category.

48. The server computer of claim 44 wherein the instructions further comprises:
a lead pricing module for conducting auctions for share sales in a series of auctions wherein the reserve price for an auction in a series depends on the sale price achieved in auctions of leads within the lead category for the lead as compared to the sale price achieved in auctions outside of the lead category for the lead.

49. A server computer operable to monetize the value of leads by providing a mechanism by which leads are sold and conferring a benefit from such sales to third party recipients, comprising:
a processor connected to a storage system and having a communications interface by which the processor communicates over a computer network;
the storage system comprising instructions to cause the server to receive and transmit messages to client computers over the computer network, the instructions comprising:
instructions to receive leads from a lead contributor, instructions to alert potential providers of the existence of the lead, instructions to receive offers to purchase the lead details from the potential providers, and instructions to provide a portion of revenue raised from the sale of the lead to a potential provider to a third party recipient.

50. The server computer of claim 49 wherein the storage system further comprises a database having entries describing users as lead contributors, lead providers and designated third party recipients, entries for categorizing leads, entries for leads created by users, and entries for managing lead purchases.
